(19) United States
(12) Patent Application Publication
(10) Pub. No.: US 2026/0303587 A1
(43) Pub. Date: Oct. 1, 2026

(54) SECURITY FOR AI/ML MODELS

(71) Applicant: Lenovo (United States) Inc., Morrisville, NC (US)

(72) Inventor: Sheeba Backia Mary Baskaran, Friedrichsdorf (DE)

(73) Assignee: Lenovo (United States) Inc., Morrisville, NC (US)

(21) Appl. No.: 19/091,661

(22) Filed: Mar. 26, 2025

(51) Int. Cl. H04L 9/40; H04W 24/02

(52) U.S. Cl. CPC H04L 63/0807; H04W 24/02

(57) ABSTRACT

Various aspects of the present disclosure relate to security for AI/ML models. An apparatus, such as a UE or an NE, transmits a first message including a request for an access token, wherein the first message includes first AI/ML model information. The apparatus receives a second message including the access token, wherein the access token includes second AI/ML model information. The access token can be used, along with other authorization information, to perform different AI/ML model management tasks.

### TECHNICAL FIELD

The present disclosure relates to wireless communications, and more specifically to artificial intelligence (AI) and machine learning (ML) in wireless communications.

### BACKGROUND

A wireless communications system may include one or multiple network communication devices, which may be otherwise known as network equipment (NE), supporting wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

An apparatus (UE, NE) for wireless communication is described. The apparatus may be configured to, capable of, or operable to perform one or more operations as described herein. For example, the apparatus may be configured to, capable of, or operable to transmit a first message including a request for an access token, wherein the first message includes first AI/ML model information; and receive a second message including the access token, wherein the access token includes second AI/ML model information.

A processor (e.g., a standalone processor chipset, or a component of an apparatus (UE, NE)) for wireless communication is described. The processor may be configured to, capable of, or operable to perform one or more operations as described herein. For example, the processor may be configured to, capable of, or operable to transmit a first message including a request for an access token, wherein the first message includes first AI/ML model information; and receive a second message including the access token, wherein the access token includes second AI/ML model information.

A method performed or performable by an apparatus (UE, NE) for wireless communication is described. The method may include transmitting a first message including a request for an access token, wherein the first message includes first AI/ML model information; and receiving a second message including the access token, wherein the access token includes second AI/ML model information.

In some implementations of the apparatus (UE, NE), the processor, and the method described herein, the first AI/ML model information includes an indication of one or more of an AI/ML model training service request, an AI/ML model storage service request, an AI/ML model retrieval service request, an AI/ML model management service request, or an AI/ML model discovery service request.

In some implementations of the apparatus (UE, NE), the processor, and the method described herein, the first AI/ML model information includes one or more of: an authorization scope parameter associated with the access token; an identifier for an artificial intelligence AI/ML server; or an identifier for an AI/ML model repository.

In some implementations of the apparatus (UE, NE), the processor, and the method described herein, the authorization scope parameter includes one or more of: AI/ML service information associated with AI/ML model management; one or more of vertical application layer (VAL) service information, a VAL server identifier (ID), a VAL UE ID, AI/ML enabler (AIMLE) client ID, or AI/ML client ID; or one or more of an AI/ML model ID, an AI/ML model address, or an analytics ID.

In some implementations of the apparatus (UE, NE), the processor, and the method described herein, the AI/ML service information associated with AI/ML model management includes information for one or more AI/ML model retrieval services.

In some implementations of the apparatus (UE, NE), the processor, and the method described herein, the apparatus includes an AI/ML client, an AIMLE client, a VAL server, or a VAL UE.

An apparatus (UE, NE) for wireless communication is described. The apparatus may be configured to, capable of, or operable to perform one or more operations as described herein. For example, the apparatus may be configured to, capable of, or operable to receive a first message including a request for an access token, wherein the first message includes first AI/ML model information; and transmit a second message including the access token, wherein the access token includes second AI/ML model information.

A processor (e.g., a standalone processor chipset, or a component of an apparatus (UE, NE)) for wireless communication is described. The processor may be configured to, capable of, or operable to perform one or more operations as described herein. For example, the processor may be configured to, capable of, or operable to receive a first message including a request for an access token, wherein the first message includes first AI/ML model information; and transmit a second message including the access token, wherein the access token includes second AI/ML model information.

A method performed or performable by an apparatus (UE, NE) for wireless communication is described. The method may include receiving a first message including a request for an access token, wherein the first message includes first AI/ML model information; and transmitting a second message including the access token, wherein the access token includes second AI/ML model information.

In some implementations of the apparatus (UE, NE), the processor, and the method described herein, the first AI/ML model information includes an indication of one or more of an AI/ML model training service request, an AI/ML model storage service request, an AI/ML model retrieval service request, an AI/ML model management service request, or an AI/ML model discovery service request; and the second AI/ML model information includes one or more of AI/ML model training information, AI/ML model storage information, or AI/ML model discovery information.

In some implementations of the apparatus (UE, NE), the processor, and the method described herein, the second AI/ML model information includes one or more of: authorization scope information for AI/ML model management; one or more of an AI/ML server ID, AIMLE client ID, or an AI/ML model repository ID; one or more of VAL service information or VAL server information; one or more allowed AI/ML model retrieval filters; one or more of an AI/ML model ID, an AI/ML model address, or an analytics ID; or an authorization server ID.

An apparatus (UE, NE) for wireless communication is described. The apparatus may be configured to, capable of, or operable to perform one or more operations as described herein. For example, the apparatus may be configured to, capable of, or operable to transmit a first message including an AI/ML model request, wherein the first message includes one or more of security credentials, authorization information, or an access token; and receive a second message including a response to the AI/ML model request.

A processor (e.g., a standalone processor chipset, or a component of an apparatus (UE, NE)) for wireless communication is described. The processor may be configured to, capable of, or operable to perform one or more operations as described herein. For example, the processor may be configured to, capable of, or operable to transmit a first message including an AI/ML model request, wherein the first message includes one or more of security credentials, authorization information, or an access token; and receive a second message including a response to the AI/ML model request.

A method performed or performable by an apparatus (UE, NE) for wireless communication is described. The method may include transmitting a first message including an AI/ML model request, wherein the first message includes one or more of security credentials, authorization information, or an access token; and receiving a second message including a response to the AI/ML model request.

In some implementations of the apparatus (UE, NE), the processor, and the method described herein, the AI/ML model request includes a request for AI/ML model retrieval, and wherein the one or more of the security information, the authorization information, or the access token includes AI/ML model retrieval information.

In some implementations of the apparatus (UE, NE), the processor, and the method described herein, the request for AI/ML model retrieval is associated with one or more of a request to subscribe to AI/ML model retrieval, a request to subscribe to AI/ML model retrieval notification, a request to subscribe to AI/ML model update, or a request to unsubscribe to AI/ML model retrieval.

In some implementations of the apparatus (UE, NE), the processor, and the method described herein, the AI/ML model request includes a request for AI/ML model training or AI/ML model training notification, and wherein the one or more of the authorization information or the access token includes AI/ML model training information.

In some implementations of the apparatus (UE, NE), the processor, and the method described herein, the AI/ML model request includes a request for AI/ML model storage management, and wherein the one or more of the authorization information or the access token includes AI/ML model storage management information.

In some implementations of the apparatus (UE, NE), the processor, and the method described herein, the apparatus includes an AI/ML client, an AIMLE client, or a VAL server.

In some implementations of the apparatus (UE, NE), the processor, and the method described herein, the security credentials include one or more of a client certificate or a root certificate configured to validate a client certificate.

An apparatus (UE, NE) for wireless communication is described. The apparatus may be configured to, capable of, or operable to perform one or more operations as described herein. For example, the apparatus may be configured to, capable of, or operable to receive a first message including an AI/ML model request, wherein the first message includes one or more of security credentials, authorization information, or an access token; and transmit a second message including a response to the AI/ML model request, wherein the response is generated based on at least in part on one or more of the security credentials, authorization information or the access token.

A processor (e.g., a standalone processor chipset, or a component of an apparatus (UE, NE)) for wireless communication is described. The processor may be configured to, capable of, or operable to perform one or more operations as described herein. For example, the processor may be configured to, capable of, or operable to receive a first message including an AI/ML model request, wherein the first message includes one or more of security credentials, authorization information, or an access token; and transmit a second message including a response to the AI/ML model request, wherein the response is generated based on at least in part on one or more of the security credentials, authorization information or the access token.

A method performed or performable by an apparatus (UE, NE) for wireless communication is described. The method may include receiving a first message including an AI/ML model request, wherein the first message includes one or more of security credentials, authorization information, or an access token; and transmitting a second message including a response to the AI/ML model request, wherein the response is generated based on at least in part on one or more of the security credentials, authorization information or the access token.

In some implementations of the apparatus (UE, NE), the processor, and the method described herein, the AI/ML model request includes a request for AI/ML model retrieval, and the apparatus, the processor, and the method may further be configured to, capable of, operable to, performed to, or performable to perform an authorization procedure using at least a portion of the one or more of the security credentials, the authorization information, or the access token, wherein the response to the AI/ML model request includes a response to the request for AI/ML model retrieval that is generated based at least in part on a result of the authorization procedure.

In some implementations of the apparatus (UE, NE), the processor, and the method described herein, the request for AI/ML model retrieval is associated with one or more of a request to subscribe to AI/ML model retrieval, a request to subscribe to AI/ML model retrieval notification, a request to subscribe to AI/ML model update, or a request to unsubscribe to AI/ML model retrieval.

In some implementations of the apparatus (UE, NE), the processor, and the method described herein, the AI/ML model request includes a request for AI/ML model training, and the apparatus, the processor, and the method may further be configured to, capable of, operable to, performed to, or performable to perform an authorization procedure using at least a portion of the one or more of the security credentials, the authorization information, or the access token, wherein the response to the AI/ML model request includes a response to the request for AI/ML model training that is generated based at least in part on a result of the authorization procedure.

In some implementations of the apparatus (UE, NE), the processor, and the method described herein, the AI/ML model request includes a request for AI/ML model storage management, and the apparatus, the processor, and the method may further be configured to, capable of, operable to, performed to, or performable to perform an authorization procedure using at least a portion of the one or more of the security credentials, the authorization information, or the access token, wherein the response to the AI/ML model request includes a response to the request for AI/ML model storage management that is generated based at least in part on a result of the authorization procedure.

In some implementations of the apparatus (UE, NE), the processor, and the method described herein, the security credentials include one or more of a client certificate or a root certificate configured to validate a client certificate.

### BRIEF DESCRIPTION OF THE DRAWINGS

FIG. 1 illustrates an example of a wireless communications system in accordance with aspects of the present disclosure.

FIG. 2 illustrates an example system in accordance with aspects of the present disclosure.

FIG. 3 illustrates an example system in accordance with aspects of the present disclosure.

FIG. 4 illustrates an example system in accordance with aspects of the present disclosure.

FIG. 5 illustrates an example system in accordance with aspects of the present disclosure.

FIG. 6 illustrates an example system in accordance with aspects of the present disclosure.

FIG. 7 illustrates an example system in accordance with aspects of the present disclosure.

FIG. 8 illustrates an example system in accordance with aspects of the present disclosure.

FIG. 9 illustrates a system in accordance with aspects of the present disclosure.

FIG. 10 illustrates a system in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of an NE in accordance with aspects of the present disclosure.

FIG. 14 illustrates a flowchart of a method in accordance with aspects of the present disclosure.

FIG. 15 illustrates a flowchart of a method in accordance with aspects of the present disclosure.

FIG. 16 illustrates a flowchart of a method in accordance with aspects of the present disclosure.

FIG. 17 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. A wireless communications systems can utilize AI/ML (which may also be referred to herein as “AI” or “ML”) for a variety of different purposes, such as for network operation, network optimization, automated processing (e.g., self-driving cars in vehicle to everything (V2X) scenarios), network planning, security information and event management (SIEM)), etc. AI/ML can leverage AI/ML models (which may be referred to herein as “models”), which represent programs and/or algorithms trained on a set of data to provide outputs, such as to recognize patterns, make decisions, generate content, etc. AI/ML models, for instance, can apply different algorithms to data inputs to provide data output for performing different tasks.

In some wireless communications systems, an AI/ML enabler service framework supports ML model retrieval, ML model training, and ML model management procedures where an AIMLE client or VAL server can retrieve ML models from an AIMLE server. The VAL server can train the ML models based on a request to the AIMLE Server. Based on a request from an AI/ML consumer, the AIMLE server can store the ML model information in a ML repository, e.g., an AIMLE consumer-initiated ML model information storage. AI/ML model management procedures implemented by some wireless communications systems may not support sufficient authorization and verification, which may result in different security vulnerabilities.

In one example, an unauthorized AIMLE client or VAL server can request and obtain an ML model from the AIMLE server for which the AIMLE client/VAL server does not have permission to access, which can cause different security threats, including data breaches, intellectual property theft, model compromise, and disruption of operations, which can potentially impact sensitive data and applications. In another example, an unauthorized VAL server involved in ML model training can cause malicious ML model training, which can cause different security threats such as data poisoning, model theft, and compromised accuracy, which can in turn lead to security vulnerabilities, ethical concerns, and potential harm. In another example, an unauthorized AIMLE consumer (e.g., an AIMLE consumer such as an AIMLE client or a VAL server) can perform ML model information storage and access, which can lead to risks such as data breaches, model theft, data poisoning, and adversarial attacks, which may result in security and operational disruptions.

Aspects of the present disclosure are described in the context of a wireless communications system, and include implementations that provide a secure environment in which different ML model tasks can be performed. In some implementations, procedures are described to authorize a client (AIMLE client, VAL server, VAL UE) to perform ML model management of ML model information related to one or more of the ML model ID(s) or analytics ID(s). Examples of ML model management include ML model retrieval services related service operations such as ML model retrieval request/response, ML model retrieval subscribe request/response, ML model retrieval notification, ML model retrieval subscription update request/response, ML model retrieval unsubscribe request/response, etc. In some examples, client authorization can be performed by an authorization server (SEAL identity management (SIM) server, AIMLE server, service enabler architecture layer (SEAL) server) by issuing an access token or authorization information.

In some implementations, an authorization server can verify the authorization of a client and provide access to AIMLE services related to ML model retrieval based on a client request to access ML model services for one or more ML model IDs/analytics IDs. Examples of ML model services include ML model retrieval services, ML model training services, and ML model storage services.

By performing the described techniques, a wireless communications system can implement secure procedures for controlling access to different AI/ML services and resources. The described techniques can reduce unauthorized access to AI/ML services and resources, which can reduce security threats and reduce unauthorized resource usage in wireless communications systems that utilize AI/ML functionality.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

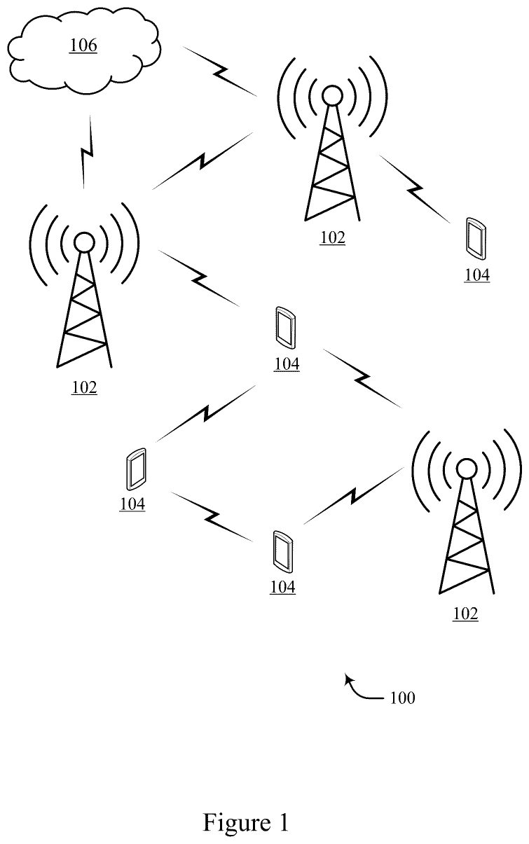

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., u=0) may be associated with a first subcarrier spacing (e.g., 15 kHz) and a normal cyclic prefix. In some implementations, the first numerology (e.g., u=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, an apparatus (e.g., the NE 102, UE 104) are operable to implement various aspects of the techniques described with reference to the present disclosure. For example, the apparatus can transmit a first message including a request for an access token, wherein the first message includes first AI/ML model information; and receive a second message including the access token, wherein the access token includes second AI/ML model information.

According to implementations, an apparatus (e.g., the NE 102, UE 104) are operable to implement various aspects of the techniques described with reference to the present disclosure. For example, the apparatus can receive a first message including a request for an access token, wherein the first message includes first AI/ML model information; and transmit a second message including the access token, wherein the access token includes second AI/ML model information.

According to implementations, an apparatus (e.g., the NE 102, UE 104) are operable to implement various aspects of the techniques described with reference to the present disclosure. For example, the apparatus can transmit a first message including an AI/ML model request, wherein the first message includes one or more of security credentials, authorization information, or an access token; and receive a second message including a response to the AI/ML model request.

According to implementations, an apparatus (e.g., the NE 102, UE 104) are operable to implement various aspects of the techniques described with reference to the present disclosure. For example, the apparatus can receive a first message including an AI/ML model request, wherein the first message includes one or more of security credentials, authorization information, or an access token; and transmit a second message including a response to the AI/ML model request, wherein the response is generated based on at least in part on one or more of the security credentials, authorization information or the access token.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

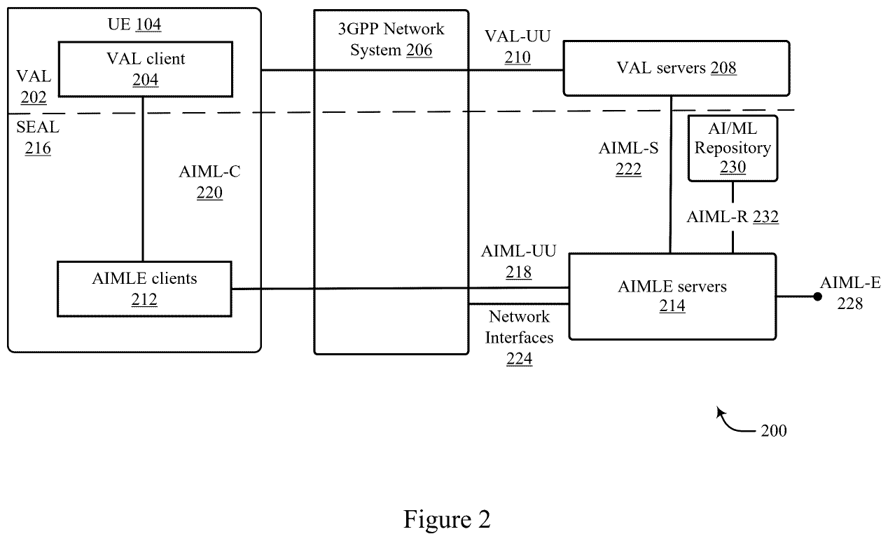

FIG. 2 illustrates an example system 200 in accordance with aspects of the present disclosure. The system 200 represents an example on-network functional model of AI/ML enablement (AIMLE). In a VAL 202, a VAL client 204 (e.g., as part of a UE 104) communicates via a 3GPP network system 206 with VAL servers 208 over a VAL-UU reference point 210. VAL-UU can support unicast and multicast delivery modes. The AIMLE functional entities on the UE 104 and the server are grouped into AIMLE clients 212 and AIMLE servers 214, respectively.

At a SEAL 216 for verticals, the system 200 includes of a common set of services for AIML functionality, including federated learning (FL) and distributed learning (e.g., FL client registration management, FL client discovery and selection), and reference points. The AIMLE services can be provided to the VAL 202. The AIMLE clients 212 can communicate with the AIMLE servers 214 over AIML-UU reference points 218. The AIMLE clients 212 can provide functionality to the VAL client 204 over an AIML-C reference point 220. The VAL servers 208 can communicate with the AIMLE servers 214 over AIML-S reference points 222. The AIMLE servers 214 communicate with the 3GPP network system 206 using 3GPP network interfaces 224 specified by the 3GPP network system 206. An AIML-E reference point 228 enables interactions between multiple AIMLE servers 214, e.g., between central and edge AIMLE servers 214. An AIMLE server 214 can interact with an AI/ML repository 230, which serves as repository for AI/ML models and AI/ML participants over AIML-R 232.

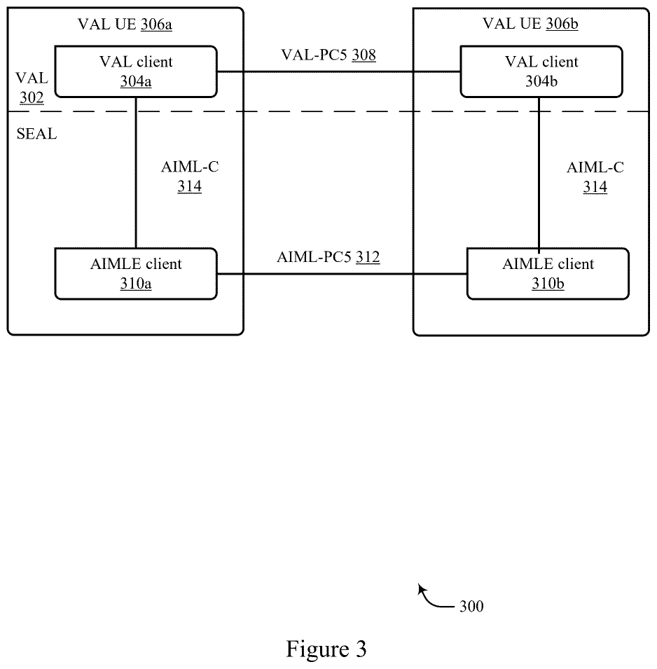

FIG. 3 illustrates an example system 300 in accordance with aspects of the present disclosure. The system 300 represents an example off-network functional model of AIMLE. In a VAL 302, a VAL client 304a at a VAL UE 306a communicates with a VAL client 304b at a VAL UE 306b over VAL-PC5 reference point 308. VAL-PC5 can support unicast and multicast delivery modes. The VAL UE 306a, if connected to the network via a Uu reference point, can also act as a UE-to-network relay to enable the VAL UE 306b to access VAL servers over a VAL-UU reference point. An AIMLE client 310a at the VAL UE 306a can communicate with an AIMLE client 310b at the VAL UE 306b over AIML-PC5 reference points 312. An AIMLE client 310 can provide functionality to the VAL clients 304 over AIML-C reference points 314. Such communication can support local AI/ML operations (training, distribution, inference) in a coordinated manner.

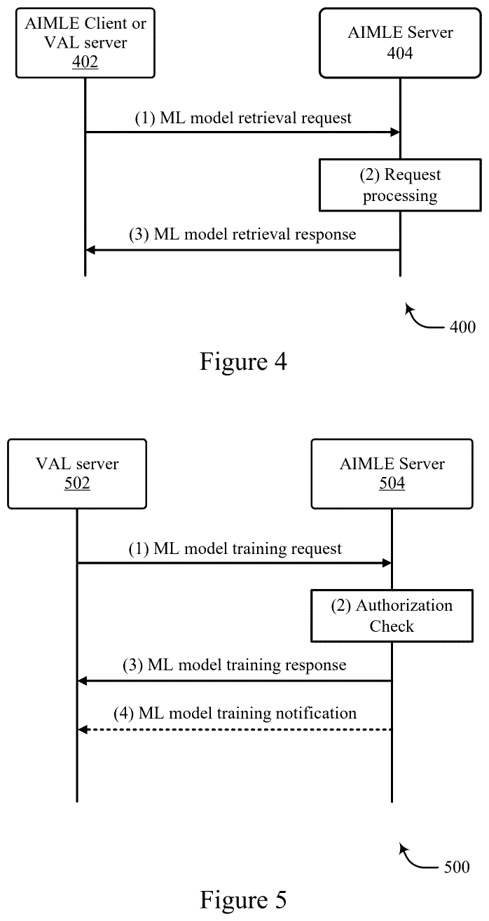

FIG. 4 illustrates an example system 400 in accordance with aspects of the present disclosure. The system 400 represents an example for AI/ML model retrieval. In the system 400: At step (1), a requestor 402 (e.g., AIMLE client or VAL server) sends a ML model retrieval request to an AIMLE server 404. The request includes the requestor identifier along with security credentials and may include ML model retrieval filters. At step (2), upon receiving the request from the requestor 402, the AIMLE server 404 validates if the requestor 402 is authorized for the request. If the requestor 402 is authorized, the AIMLE server 404 may determine if the requested ML model is available with the AIMLE server 404 based on ML model retrieval filters. If the ML model is not available with the AIMLE server 404, the AIMLE server 404 can perform an ML model information discovery procedure with an ML repository. If the request is received from an AIMLE client that has registered with the AIMLE server 404, the AIMLE server 404 can determine the ML model based on an AIMLE client profile, e.g., supported AI/ML model types and/or application layer AIMLE client capabilities.

At step (3), the AIMLE server 404 sends a ML model retrieval response to the requestor 402. If the AIMLE server 404 has determined ML models (e.g., locally, or from the ML repository), the response includes an indication of success and may include the ML models. Otherwise, the response includes an indication of failure and may include a reason for failure. Upon receiving a response including ML models, the requestor 402 can store the ML models and may provide the ML model to the VAL clients, e.g., if the requestor 402 is the AIMLE client.

This ML model retrieval procedure may not support authorization and related verification, therefore, an unauthorized AIMLE client or VAL server can request and obtain the ML model from the AIMLE for which the AIMLE client/VAL server has no permission to access. Such scenarios can lead to threats, including data breaches, intellectual property theft, model compromise, and disruption of operations, potentially impacting sensitive data and applications.

FIG. 5 illustrates an example system 500 in accordance with aspects of the present disclosure. The system 500 represents an example for AI/ML model training. In the system 500: At step (1) a VAL server 502 sends an ML model training request to an AIMLE server 504 requesting to assist in ML model training. The request includes ML model information or ML model requirement information. At step (2), the AIMLE server 504 checks whether the VAL server 502 is authorized to perform the ML model training request. If no model information is provided but only the model requirement information is provided at (1), the AIMLE server 504 can identify and select an ML model for training based on the ML model information. At step (3), if the VAL server 502 is authorized, the AIMLE server 504 returns the success response, otherwise a failure response indication the reason for failure. At step (4), the AIMLE server 504 notifies the VAL server 502 to update the list of FL/ML clients selected or de-selected for the ML model training or to share the training output or any errors during the training process.

This ML model training procedure may not support authorization and related verification, therefore, unauthorized VAL server involving in ML model training can cause malicious ML model training. Such scenarios can lead to threats such as data poisoning, model theft, and compromised accuracy, leading to security vulnerabilities, ethical concerns, and potential harm.

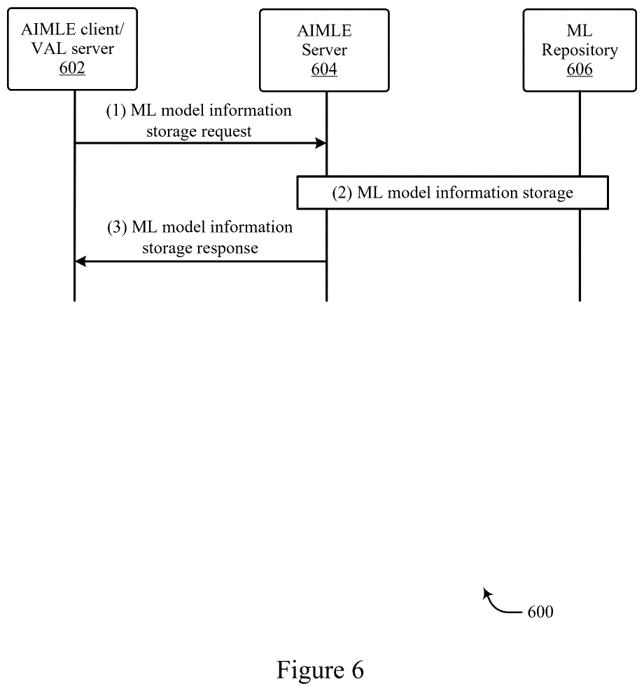

FIG. 6 illustrates an example system 600 in accordance with aspects of the present disclosure. The system 600 represents an example for AI/ML model information storage. In the system 600: At step (1) an AIMLE client or a VAL server 602 (AIMLE client/VAL server) sends an ML model information storage request to an AIMLE server 604 to store an ML model in an ML repository 606. At step (2) the AIMLE server 604 sends an ML model information storage request to store the ML model in the ML repository 606. At step (3) the AIMLE server 604 sends an ML model information storage response to the AIMLE client/VAL server 602 with information elements.

This AIMLE ML model information storage procedure may not support authorization and related verification, therefore, an unauthorized AIMLE consumer (e.g., AIMLE consumer such as AIMLE client or VAL server) performing ML model information storage and access can lead to risks such as data breaches, model theft, data poisoning, and adversarial attacks, leading to security and operational disruptions.

Aspects of the present disclosure include solutions for security for AI/ML models. Implementations, for example, provide solutions to enable a wireless communications system to implement secure procedures for performing different tasks associated with AI/ML model management.

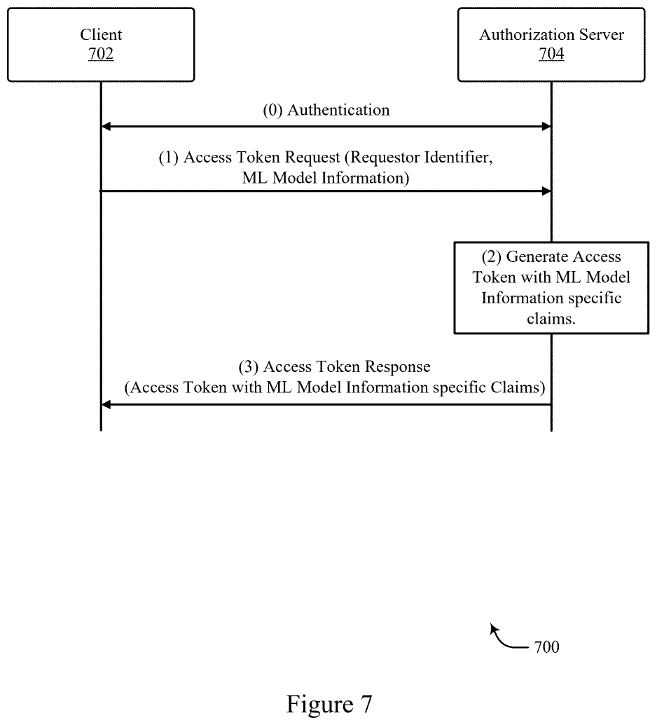

FIG. 7 illustrates an example system 700 in accordance with aspects of the present disclosure. The system 700 can be implemented to authorize a client 702 (e.g., AIMLE client, VAL server, VAL UE) to perform AI/ML model management. Examples of AI/ML model management include AI/ML model retrieval services related service operations such as ML model retrieval request/response, ML model retrieval subscribe request/response, AI/ML model retrieval notification, ML model retrieval subscription update request/response, AI/ML model retrieval unsubscribe request/response, etc. AI/ML model management may involve AI/ML model information related to one or more of ML model IDs or analytics IDs. The authorization of the client 702 can be performed via interaction with an authorization server 704 (e.g., a SIM server, an AIMLE server, a SEAL server) by issuing an access token or authorization information.

In the system 700: At step (0), the client 702 and the authorization server perform mutual authentication. At step (1), the client 702 communicates (e.g., transmits, sends) an access token request including a requestor identifier for the client 702 and AI/ML model information. At step (2), and based on the access token request, the authorization server 704 generates an access token with claims that are specific to the AI/ML model information. At step (3), the authorization server 704 communicates an access token response to the client 702 that includes the generated access token.

In some implementations, to obtain an access token (and optionally a refresh token), the client 702 can communicate a constrained application protocol (CoAP) request to the authorization server 704 token endpoint by sending parameters from Table 1 below using “application/ace+cbor” content format and with a concise binary object representation (CBOR) map in the CoAP payload. Alternatively, or in addition, the access token request can be one of an AIMLE service access token request or an AIMLE AI/ML model retrieval access token request.

TABLE 1

| Parameter | Values |
|---|---|
| scope | OPTIONAL. This field requests authorization scopes for the access |
| | token. |
| | This field requests AIMLE service-related information related to ML |
| | model management (such as ML model retrieval services related |
| | service operations such as ML model retrieval request/response, ML |
| | model retrieval subscribe request/response, ML model retrieval |
| | notification, ML model retrieval subscription update |
| | request/response, ML model retrieval unsubscribe request/response |
| | etc., |
| | VAL service ID/information, |
| | VAL server ID/VAL UE ID/AIMLE Client ID etc., |
| | Model Information such as ML Model ID(s)/address or Analytics |
| | IDs. |
| audience | OPTIONAL. This field requests specific SEAL servers/resources for |
| | the access token. The field requests specific AIMLE server/AIMLE |
| | Model repository for the AIMLE related services. |
| cnonce | May be used if a client-nonce was provided in response to an |
| | unauthorized resource request to a SEAL server/resource. |
| req_cnf | OPTIONAL. This field contains information about the key the SEAL |
| | client wants to bind to the access token for proof-of-possession. |

For an access token response, if the access token request is valid and authorized, the authorization server 704 can return an access token (and optionally a refresh token) to the client 702 in an access token response message; otherwise, it will return an error. Table 2 includes example access token response parameters.

TABLE 2

| Parameter | Values |
|---|---|
| access_token | This is the issued access token. The access token includes the |
| | claims Requestor ID as subject, |
| | scope as (AIMLE service-related information related to ML |
| | model management (such as ML model retrieval |
| | services related service operations such as ML model |
| | retrieval request/response, ML model retrieval subscribe |
| | request/response, ML model retrieval notification, ML |
| | model retrieval subscription update request/response, |
| | ML model retrieval unsubscribe request/response etc., |
| | audience claim as (AIMLE server/AIMLE Model repository for |
| | the AIMLE related services), |
| | VAL service ID/information, |
| | VAL server ID/VAL UE ID/AIMLE Client ID etc., |
| | allowed ML model retrieval filters, and |
| | Model Information such as ML Model ID(s)/address or |
| | Analytics IDs.), |
| | Issuer claim as Authorization Server ID, |
| | AIMLE server ID/SEAL server ID. |
| expires_in | The lifetime in seconds of the access token. |
| refresh_token | OPTIONAL. This is the issued refresh token. |
| ace_profile | This field indicates the IETF ACE profile the SEAL client shall |
| | use towards the SEAL server/resource. |
| cnf | OPTIONAL. This field is REQUIRED for symmetric key |
| | usages unless the secret key is known to the SEAL client (e.g. |
| | in case of update of access rights). |
| rs_cnf | OPTIONAL. This field is REQUIRED for asymmetric key |
| | usages unless the public key of the SEAL server is known to the |
| | SEAL client (e.g. in case of update of access rights). |

The client 702 may use the access token to make protected and authorized requests to the authorization server 704. Implementations such as described with reference to the system 700 can be used for an access request related to AI/ML model training request with the following adaptations. The client 702 can obtain, in the step (3) access token response message, the authorization information and/or access token which includes token claims such as requestor ID as subject, ML model training service as scope, allowed training type (vertical FL (VFL) or horizontal FL (HFL), or both VFL and HFL), allowed list of AIMLE member client IDs, allowed location information for member client selection, allowed ML model ID list/ML model information for training, allowed ML model training notification target address, ML model selection filtering criteria, issuer claim as authorization server ID, AIMLE server ID/SEAL server ID etc.) from the authorization server 704 when the access token request in step (1) indicates an ML model training service in the access token request message.

In such implementations, the access token request can include information such as training type, list of member clients, member selection criteria, ML model information, ML model requirement information, members update notification, and notification target address. Based on local configuration or authorization information, the authorization information or access token claims can additionally include the received information from the access token request such as training type, list of member clients, member selection criteria, ML model information, ML model requirement information, members update notification, and/or notification target address.

In some implementations, for ML model storage service, the client 702 can obtain the access token from the authorization server 704 as described with reference to the system 700. The client 702 can obtain in step (3) the authorization information or access token which includes claims such as requestor ID as subject, ML model storage service as scope, allowed ML information (model ID, model type, or ML model identified by analytics ID or ML model address from where ML model can be downloaded), allowed AIMLE client ID or ML model source identifier (e.g., VAL server ID, VAL client ID, target ML repository information), related VAL service ID(s), ML model address, base Model ID, analytics ID, model size, domain information, related vendor ID(s), issuer claim as authorization server ID, AIMLE server ID/SEAL server ID, etc., from the authorization server 704 when the access token request in step (1) indicates ML model storage service in the access token request message.

In some implementations, for ML model discovery service, the client 702 can obtain the access token from the authorization server 704 as described with reference to the system 700. The client 702 can obtain in step (3) the authorization information or access token, which includes claims such as requestor ID as subject, ML model discovery service as scope, VAL service ID, ML model source identifier, allowed list of AIMLE member client IDs, allowed location information for member client selection, allowed ML model ID list/ML model Information for discovery, ML model address, base model ID, analytics ID, allowed ML model training notification target address, ML model selection filtering criteria, domain information, required accuracy level, issuer claim as authorization server ID, AIMLE server ID/SEAL server ID, etc., from the authorization server 704 when the access token request in step (1) indicates ML model discovery service in the access token request message.

Implementations provide for secure ML model retrieval procedures by authorization/access permission verification for access control. For instance, the authorization server 704 (e.g., a SIM server, AIMLE server, SEAL server) can verify the authorization of the client 702 (e.g., AIMLE client, VAL Server, VAL UE) and provide access to AIMLE services related to ML model retrieval when the client 702 requests access to the ML model retrieval services for one or more ML model IDs/analytics IDs respectively as illustrated in the system 800 described below.

ML model retrieval enables applications consuming services from the AI/ML application enablement layer to retrieve ML models available with the enablement layer. ML model retrieval enables the client 702 to obtain target ML models. Retrieving ML models can be based on matching ML model retrieval filters provided in the request. ML model retrieval subscription enables the client 702 to receive notifications about target ML models. The subscription can be based on matching ML model retrieval filters provided in the subscription request.

Example procedures that are supported for ML model retrieval include: Enhanced ML model retrieval request-response procedure; enhanced ML model subscribe-notify procedures for retrieval of ML models, including: Enhanced Subscription procedure; enhanced subscription update procedure; and enhanced unsubscribe procedure.

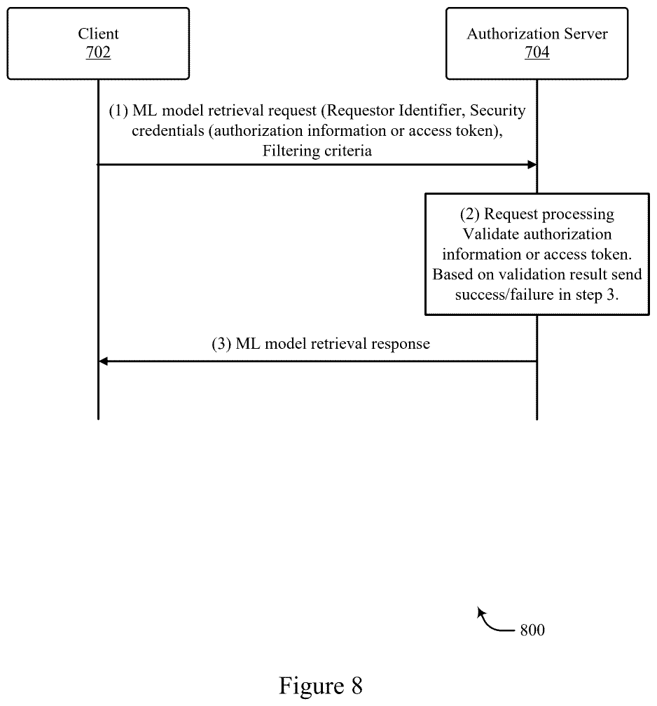

FIG. 8 illustrates an example system 800 in accordance with aspects of the present disclosure. The system 800 can be operable to implement procedures for the client 702 to discover and obtain ML models from the AIMLE server. In at least some implementations, for operation of the system 800, the client 702 has received information (e.g., URI, IP address) related to the authorization server 704. The client 702 has received security credentials (e.g., authorization token/information or access token as described herein) authorizing the client 702 to communicate with the authorization server 704.

In some implementations, authorization information or an access token can include claims such as requestor ID as subject, ML model retrieval service as scope, ML model ID list/ML model information, and ML model filtering criteria as part of scope claim, resource claim, or other related claim, issuer claim as authorization server ID, AIMLE server ID/SEAL server ID.

Alternatively, or in addition, authorization information or an access token can include claims such as requestor ID as subject, AIMLE service-related information related to ML model management such as ML model retrieval services related service operations such as ML model retrieval request/response, ML model retrieval subscribe request/response, ML model retrieval notification, ML model retrieval subscription update request/response, ML model retrieval unsubscribe request/response etc., audience claim as AIMLE server/AIMLE model repository for the AIMLE related services, VAL service ID/information, VAL server ID/VAL UE ID/AIMLE Client ID etc., allowed ML model retrieval filters, and model Information such as ML Model ID(s)/address or Analytics IDs.), issuer claim as authorization server ID, and/or AIMLE server ID/SEAL server ID.

In the system 800: At step (1), the client 702 communicates a ML model retrieval request to the authorization server 704. The request includes the requestor identifier along with security credentials, e.g., authentication information such as certificates and/or authorization token/information or access token as described herein, and may include ML model retrieval filters and/or ML Model ID(s). At step (2), upon receiving the request from the requestor, the authorization server 704 validates whether the client 702 is authorized for the request. If the client 702 is authorized, the authorization server 704 may determine if the requested ML model is available with the authorization server 704 based on ML model retrieval filters and/or ML model ID(s). If the ML model is not available with the authorization server 704, the authorization server 704 may perform a ML model information discovery procedure with an ML repository as described herein. If the client 702 has registered with the authorization server 704, the authorization server 704 verifies the received security credentials, e.g., authentication information such as certificates, authorization information or access token and if the verification is successful. The authorization server 704 may determine the ML model based on the client 702 profile, e.g. supported AI/ML model types and/or application layer AIMLE client capabilities.

In the system 800, at step (3) the authorization server 704 sends a ML model retrieval response to the client 702. If the authorization server 704 has determined ML models (e.g., locally, or from the ML repository) and based on the claims in the authorization information or access token, the response may include an indication of success and may include the ML models. Otherwise, the response includes an indication of failure and may include a reason for failure. Upon receiving a response including ML models, the client 702 can store the ML models and may provide the ML model to the VAL client(s), e.g., if the client 702 is an AIMLE client.

Implementations can provide for ML model retrieval subscription. The client 702 can subscribe with the authorization server 704 to be notified of retrieval of ML models. In some examples, the client 702 has received information (e.g. URI, IP address) related to the authorization server 704, and the client 702 has received security credentials authorizing it to communicate with the authorization server 704. The client 702 can communicate a ML model retrieval subscribe request to the authorization server 704. The request may include a requestor identifier, security credentials (e.g., authentication information such as certificates, authorization token/information, or access token as described herein) and may include ML model retrieval filters, ML Model ID(s), and/or expiration time.

Upon receiving the request from the requestor, the authorization server 704 validates if the client 702 is authorized for the request. For example, the authorization server 704 verifies the received security credentials, e.g., authentication information such as certificates, authorization information or access token, and determines whether the verification is successful. If the client 702 is authorized if the security credentials, the authorization server 704 creates a subscription based on the claims in the authorization information or access token and stores the subscription information. The authorization server 704 can send a ML model retrieval subscribe response to the client 702. If the authorization server 704 has created the subscription based on the claims in the authorization information or access token, the response includes an indication of success and the subscription identity, and may include an expiration time. To maintain the subscription, the client 702 can send a subscription update request before the expiration time, otherwise the ML model retrieval subscription may expire. If the authorization server 704 has not created the subscription, the response may include an indication of failure and a reason for failure.

Implementations may include ML model retrieval notify operations between the authorization server 704 and the client 702. The client 702 may have subscribed for ML model retrieval with the authorization server 704. An event may occur at the authorization server 704 that satisfies trigger conditions for notifying a subscriber, e.g., the client 702. The event may be the detection of availability of new ML model(s) (e.g., new ML model or new revision of a ML model) that satisfies the ML model retrieval filters of the subscription, or changes in the client 702 profile. For example, the authorization server 704 receives an updated AIMLE client profile with updated “supported AI/ML model type” which indicates the existing model is no longer supported and a new model is to be retrieved. The authorization server 704 may send a ML model retrieval notification to the client 702 indicating newly available ML models. The notification may include a subscription identity and newly available ML model(s).

Implementations may include procedures for the client 702 to update a subscription with the authorization server 704. The client 702 may have subscribed for ML model retrieval with the authorization server 704. The client 702 may communicate a ML model retrieval update request to the authorization server 704. The request may include the requestor identifier, security credentials (e.g., authentication information such as certificates, authorization token/information, or access token as described herein) and the subscription identifier and may include ML model retrieval filters, ML model ID(s), and expiration time. Upon receiving the request from the client 702, the authorization server 704 may validate whether the requestor is authorized for the request. For example, the authorization server 704 may verify the received security credentials (e.g., authentication information such as certificates, authorization information, or access token), and whether the verification is successful. If the client 702 is authorized (e.g., if the security credentials verification is successful), the authorization server 704 may update the subscription information.

The authorization server 704 may send a ML model retrieval subscription update response to the client 702. If the authorization server 704 has updated the subscription based on the claims in the authorization information or access token, the response may include an indication of success and may include an expiration time. To maintain the subscription, the client 702 may send a subscription update request before the expiration time, otherwise the ML model retrieval subscription may expire. If the authorization server 704 has not updated the subscription, the response may include an indication of failure and may include a reason for failure.

Implementations may provide procedures for the client 702 to unsubscribe with the authorization server 704. The client 702 may have subscribed for ML model retrieval with the AIMLE Server, and the client 702 may send a ML model retrieval unsubscribe request to the authorization server 704. The request may include the requestor identifier, security credentials as described herein, and the subscription identifier. Upon receiving the request from the client 702, the authorization server 704 may validate whether the client 702 is authorized for the request. For example, the authorization server 704 verifies the received security credentials and whether the verification is successful. If the client 702 is authorized (e.g., if security credentials verification is successful), the authorization server 704 may cancel the subscription. The authorization server 704 may communicate a ML model retrieval unsubscribe response to the client 702. If the authorization server 704 has canceled the subscription based on the claims in the authorization information or access token, the response may include an indication of success. If the authorization server 704 has not canceled the subscription, the response may include an indication of failure and may include a reason for failure.

Table 3 describes example information elements for an ML model retrieval request from the client 702 to the authorization server 704. In some examples, authorization information or an access token can be part of security credentials. In some examples, if security credentials and authorization information/access token are in a separate information element (IE), then security credentials can include client certificate and/or root certificate to validate the client certificate.

TABLE 3

| Information element | Description |
|---|---|
| Requestor identifier | The identifier of the requestor (e.g., |
| | AIMLE client or VAL server). |
| Security credentials | The security credentials of the requestor |
| | e.g., client certificate and/or root |
| | certificate to validate the client certificate. |
| Authorization information | The access token includes the claims |
| or access token | Requestor ID as subject, scope as |
| | (AIMLE service-related information |
| | related to ML model management (such |
| | as ML model retrieval services related |
| | service operations such as ML model |
| | retrieval request/response, ML model |
| | retrieval subscribe request/response, ML |
| | model retrieval notification, ML model |
| | retrieval subscription update |
| | request/response, ML model retrieval |
| | unsubscribe request/response etc., |
| | audience claim as (AIMLE server/AIMLE |
| | Model repository for the AIMLE related |
| | services), VAL service ID/information, |
| | VAL server ID/VAL UE ID/AIMLE |
| | Client ID etc., allowed ML model |
| | retrieval filters, and Model Information |
| | such as ML Model ID(s)/address or |
| | Analytics IDs.), Issuer claim as |
| | Authorization Server ID, AIMLE server |
| | ID/SEAL server ID. |
| Filtering criteria | Represents the filtering criteria, which can |
| | be any of the ML model information as in |
| | Table 8.11.4.1-2. |
| Model ID/Information | The Model ID/Information identifies one |
| | or more AIML models which the |
| | requestor (e.g., AIMLE client or VAL |
| | server) is authorized to access/retrieve or |
| | use. |

Table 4 describes example IEs for a ML model retrieval response from the authorization server 704.

TABLE 4

| IE | Description |
|---|---|
| Successful response | Indicates that the ML model retrieval |
| | request was successful. |
| >List of ML models | List of retrieved ML models; the nested |
| | information elements are provided for |
| | each ML model in the list. |
| >> ML model identifier | The ML model identifier. |
| >> ML model retrieval | The endpoint (e.g., URL, URI, IP address) |
| endpoint (NOTE) | where the ML model file can be retrieved. |
| >> ML model (NOTE) | The ML model containing a retrieved ML |
| | model. |
| Failure response | Indicates that the request has failed. |
| > Cause | The cause for the request failure. |

Table 5 describes example IEs for the ML model retrieval subscription request from the client 702 to the authorization server 704.

TABLE 5

| Information element | Description |
|---|---|
| Requestor identifier | The identifier of the requestor (e.g., |
| | AIMLE client or VAL server). |
| Security credentials | The security credentials of the requestor |
| | e.g., client certificate and/or root certificate |
| | to validate the client certificate. |
| Authorization information | The access token includes the claims |
| or access token | Requestor ID as subject, scope as (AIMLE |
| | service-related information related to ML |
| | model management (such as ML model |
| | retrieval services related service operations |
| | such as ML model retrieval |
| | request/response, ML model retrieval |
| | subscribe request/response, ML model |
| | retrieval notification, ML model retrieval |
| | subscription update request/response, ML |
| | model retrieval unsubscribe |
| | request/response etc., audience claim as |
| | (AIMLE server/AIMLE Model repository |
| | for the AIMLE related services), VAL |
| | service ID/information, VAL server |
| | ID/VAL UE ID/AIMLE Client ID etc., |
| | allowed ML model retrieval filters, and |
| | Model Information such as ML Model |
| | ID(s)/address or Analytics IDs.), Issuer |
| | claim as Authorization Server ID, AIMLE |
| | server ID/SEAL server ID. |
| Notification Target | Notification target address (e.g. URL) |
| Address | where the notifications should be sent. |
| Proposed expiration time | Proposed expiration time for the |
| | subscription. |
| Filtering criteria | Represents the filtering criteria, which can |
| | be ML model information. |
| Model ID/Information | The Model ID/Information identifies one or |
| | more AIML models which the requestor |
| | (e.g., AIMLE client or VAL server) is |
| | authorized to access/retrieve or use. |

Table 6 describes example IEs for the ML model retrieval subscription response from the authorization server 704 to the client 702.

TABLE 6

| Information element | Description |
|---|---|
| Successful response | Indicates that the ML model retrieval |
| | request was successful. |
| > Subscription ID | Subscription identifier corresponding to |
| | the subscription. |
| > Expiration time | Indicates the expiration time of the |
| | subscription. To maintain an active |
| | subscription, a subscription update is |
| | required before the expiration time. |
| Failure response | Indicates that the request has failed. |
| > Cause | The cause for the request failure. |

Table 7 describes example IEs for the ML model retrieval subscription response from the authorization server 704 to the client 702.

TABLE 7

| Information element | Description |
|---|---|
| Subscription ID | Subscription identifier corresponding to |
| | the subscription. |
| List of ML models | List of retrieved ML models; the nested |
| | information elements are provided for |
| | each ML model in the list. |
| > ML model identifier | The ML model identifier. |
| > ML model retrieval | The endpoint (e.g., URL, URI, IP address) |
| endpoint (NOTE) | where the ML model file can be retrieved. |
| > ML model | The ML model containing a retrieved ML |
| | model. |

Table 8 describes example IEs for the ML model retrieval subscription update request from the client 702 to the authorization server 704. In some examples, authorization information or an access token can be part of security credentials. In some examples, if security credentials and authorization information/access token are in a separate IE, then security credentials can include client certificate and/or root certificate to validate the client certificate.

TABLE 8

| Information element | Description |
|---|---|
| Requestor identifier | The identifier of the requestor (e.g., |
| | AIMLE client or VAL server). |
| Security credentials | The security credentials of the requestor |
| | e.g., client certificate and/or root |
| | certificate to validate the client certificate. |
| Authorization information | The access token includes the claims |
| or access token | Requestor ID as subject, scope as |
| | (AIMLE service-related information |
| | related to ML model management (such as |
| | ML model retrieval services related |
| | service operations such as ML model |
| | retrieval request/response, ML model |
| | retrieval subscribe request/response, ML |
| | model retrieval notification, ML model |
| | retrieval subscription update |
| | request/response, ML model retrieval |
| | unsubscribe request/response etc., |
| | audience claim as (AIMLE server/AIMLE |
| | Model repository for the AIMLE related |
| | services), VAL service ID/information, |
| | VAL server ID/VAL UE ID/AIMLE |
| | Client ID etc., allowed ML model |
| | retrieval filters, and Model Information |
| | such as ML Model ID(s)/address or |
| | Analytics IDs.), , Issuer claim as |
| | Authorization Server ID, AIMLE server |
| | ID/SEAL server ID. |
| Subscription ID | Subscription identifier corresponding to |
| | the subscription to be updated. |
| Notification Target | Notification target address (e.g. URL, |
| Address | URI, IP address) where the notifications |
| | should be sent. |
| Proposed expiration time | Proposed expiration time for the |
| | subscription. |
| Filtering criteria | Represents the filtering criteria, which can |
| | be ML model information |
| Model ID/Information | The Model ID/Information identifies one |
| | or more AIML models which the |
| | requestor (e.g., AIMLE client or VAL |
| | server) is authorized to access/retrieve or |
| | use. |

Table 9 describes example IEs for a ML model retrieval subscription update response from the authorization server 704 to the client 702.

TABLE 9

| Information element | Description |
|---|---|
| Successful response | Indicates that the ML model retrieval |
| | subscription update request was |
| | successful. |
| > Expiration time | Indicates the expiration time of the |
| | subscription. To maintain an active |
| | subscription, a subscription update is |
| | required before the expiration time. |
| Failure response | Indicates that the request has failed. |
| > Cause | The cause for the request failure. |

Table 10 describes example IEs for the ML model retrieval unsubscribe request from the client 702 to the authorization server 704. In some examples, authorization information or an access token can be part of security credentials. In some implementations, if security credentials and authorization information/access token are in a separate IE, then security credentials can include client certificate and/or root certificate to validate the client certificate.

TABLE 10

| Information element | Description |
|---|---|
| Requestor identifier | The identifier of the requestor (e.g., AIMLE |
| | client or VAL server). |
| Security credentials | The security credentials of the requestor |
| | e.g., client certificate and/or root certificate |
| | to validate the client certificate. |
| Authorization | The access token includes the claims |
| information or access | Requestor ID as subject, scope as (AIMLE |
| token | service-related information related to ML |
| | model management (such as ML model |
| | retrieval services related service operations |
| | such as ML model retrieval |
| | request/response, ML model retrieval |
| | subscribe request/response, ML model |
| | retrieval notification, ML model retrieval |
| | subscription update request/response, ML |
| | model retrieval unsubscribe |
| | request/response etc., audience claim as |
| | (AIMLE server/AIMLE Model repository |
| | for the AIMLE related services), VAL |
| | service ID/information, VAL server |
| | ID/VAL UE ID/AIMLE Client ID etc., |
| | allowed ML model retrieval filters, and |
| | Model Information such as ML Model |
| | ID(s)/address or Analytics IDs.), Issuer |
| | claim as Authorization Server ID, AIMLE |
| | server ID/SEAL server ID. |
| Subscription ID | Subscription identifier corresponding to the |
| | subscription to be unsubscribed. |

Table 11 describes example IEs for the ML model retrieval unsubscribe response from the authorization server 704 to the client 702.

TABLE 11

| Information element | Description |
|---|---|
| Successful response | Indicates that the ML model retrieval |
| | unsubscribe request was successful. |
| Failure response | Indicates that the request has failed. |
| > Cause | The cause for the request failure. |

Implementations provide for secure the ML model training procedure by authorization/access permission verification for access control. The authorization server 704 (e.g., AIMLE server, SEAL server) can verify the authorization of the client 702 (e.g., AIMLE client, VAL server, VAL UE) and provide services related to AIML model training when the client 702 requests access to the ML model training services for one or more ML model IDs/analytics IDs respectively as illustrated in a system 900.

In some implementations, the client 702 communicates a request to the authorization server 704 for ML model training with the security credentials, e.g., authorization token/information or an access token. The client 702 may request that the AIMLE server train a ML model by specifying the type of learning, details about the ML model to be trained, or parameters to select a ML model for training and criteria for selecting the members who can participate in the ML model training. The authorization information or access token can include claims such as requestor ID as subject, ML model training service as scope, allowed training type (VFL or HFL or both VFL and HFL), allowed list of AIMLE member client IDs, allowed location information for member client selection, allowed ML model ID list/ML model Information for training, allowed ML model training notification target address, ML Model selection filtering criteria etc. The client 702 may obtain the authorization information or access token (which includes claims such as ML model training service as scope, allowed training type (VFL or HFL or both VFL and HFL), allowed list of AIMLE member client IDs, allowed location information for member client selection, allowed ML model ID list/ML model Information for training, allowed ML model training notification target address, ML model selection filtering criteria, issuer claim as authorization server ID, AIMLE server ID/SEAL server ID etc.) from the authorization server 704 as described herein when the access token request indicates ML Model training service in the access token request message.

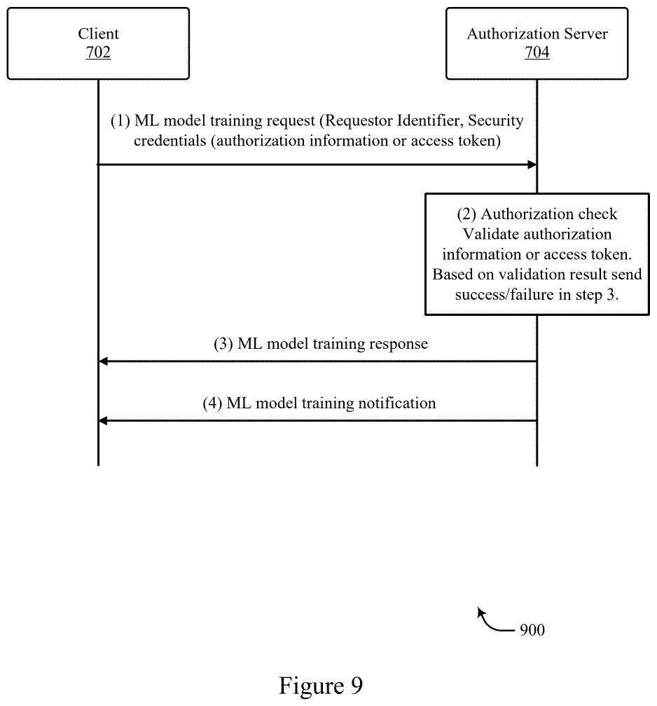

FIG. 9 illustrates a system 900 in accordance with aspects of the present disclosure. The system 900, for example, is operable to request ML model training. In the system 900: At step (1), the client 702 sends an ML model training request to the authorization server 704 requesting assistance for ML model training. The request may include ML model information or ML model parameter information and security credentials, e.g., authentication information such as certificates, authorization token/information, access token, etc.

At step (2), the authorization server 704 checks whether the client 702 is authorized to perform the ML model training request. For example, the authorization server 704 verifies the received security credentials (e.g., authentication information such as certificates, authorization information, access token). If the verification is successful, the authorization server 704 determines that the client 702 is authorized to perform the ML model training request. If no model information is provided and model parameter information is provided in step (1), the authorization server 704 may identify and select an ML model for training based on the verified claims in the authorization information or access token and based on the ML model parameter information.

At step (3), if the client 702 is authorized (e.g., the authorization server 704 verifies the received security credentials and if the verification is successful, the authorization server 704 may return a success response, otherwise a failure response indicating a reason for failure. At step (4), the authorization server 704 notifies the client 702 to update a list of FL/ML clients selected or de-selected for the ML model training or to share the training output or errors during the training process.

Table 12 describes example IEs for an example information flow from the client 702 to the authorization server 704 for requesting the ML model training. In some examples, authorization information or an access token can be part of security credentials. In some examples, if security credentials and authorization information/access token are in a separate IE, then security credentials can include client certificate and/or root certificate to validate the client certificate.

TABLE 11

| IE | Description |
|---|---|
| Requestor identity | Identity of the VAL server performing the |
| | request. |
| Security credentials | The security credentials of the requestor |
| | e.g., client certificate and/or root |
| | certificate to validate the client certificate. |
| Authorization information | The access token includes the claims such |
| or access token | as Requestor ID as subject, ML model |
| | training service as scope, Allowed |
| | Training Type (VFL or HFL or both VFL |
| | and HFL), Allowed List of AIMLE |
| | member client IDs, Allowed location |
| | information for member client selection, |
| | Allowed ML Model ID list/ML Model |
| | Information for training, allowed ML |
| | model training notification target address, |
| | ML Model selection filtering criteria, |
| | Issuer claim as Authorization Server ID, |
| | AIMLE server ID/SEAL server ID etc. |
| Training type | Identifies whether the VFL or HFL |
| | training to be performed. |
| List of member clients | List of member clients to be utilized for |
| | training the ML model. |
| Member selection criteria | Identifies the criteria that needs to be |
| | continuously monitored for selecting the |
| | member clients (e.g., AIMLE clients in a |
| | particular location, member availability |
| | duration, new member clients registering |
| | with the required capabilities). |
| ML model information | Identifies the ML model that has to be |
| | distributed to the selected member clients |
| | for training. This information consists of |
| | the model identifier, address (e.g., a URL |
| | or an FQDN) of the ML model file or |
| | address of the model repository where the |
| | ML model resides |
| ML model requirement | Identifies the requirement for selecting a |
| information | model to be trained and this information |
| | contains the filtering criteria for selecting |
| | the model. |
| Members update | Indicates whether requestor needs to be |
| notification | notified whenever there is update related |
| | to new member clients selected or de- |
| | selected. |
| Notification Target | Notification target address (e.g. URL) |
| Address | where the notifications should be sent. |

Table 12 describes example IEs for an example information flow of ML model training response from the authorization server 704 to the client 702.

TABLE 12

| Information element | Description |
|---|---|
| Success response | Indicates that the ML model training |
| | request was successful. |
| > ML model identifier | Identifies the ML model selected by |
| | AIMLE server for training. |
| Failure response | Indicates that the ML model training |
| | request was failure. |
| > Cause | Reason for the failure. |

Table 13 describes example IEs for an example information flow of ML model training notification from the authorization server 704 to the client 702.

TABLE 13

| Information element | Description |
|---|---|
| List of AIMLE clients | Indicates the list of AIMLE clients |
| | selected or de-selected for the ML model |
| | training. |
| Training output | ML model parameters for training |
| Errors list | A list of errors, if any, encountered during |
| | training process. |

Implementations can provide for how the authorization server 704 or an ML repository can verify the authorization of the client 702 and provide services related to AIML model storage when the client 702 requests access to the ML model storage services for one or more ML model IDs/Analytics IDs respectively, e.g., as illustrated in a system 1000.

In some implementations associated with a procedure of ML model information storage initiated by the authorization server 704, the authorization server 704 has either received application specific model details from an AIML consumer or produced an analytics model. The authorization server 704 can send a ML model information storage request to the ML repository to store an ML model. The ML model included in the request can be trained by the ML repository consumer. In such scenarios, the authorization information or access token specific to the AIML model storage service access, e.g., security credentials (e.g., authentication information such as certificates, authorization information or access token or its information) can be provisioned to the ML repository consumer. The request may include information elements as described in Table 14. The request message may contain Indication of continuous training and continuous training model parameter.

Upon receiving the ML model information storage request, the ML repository can verify whether the authorization server 704 is authorized to store the ML model identified by an analytics ID and/or list of the allowed vendors provided within the ML model profile attribute. For example, the authorization server 704 may verify the received security credentials, and if the verification is successful, the ML repository may determine that the authorization server 704 is authorized. If the authorization server 704 is authorized, the ML repository may process the request and record information of the ML model (e.g., by creating a ML model profile) along with the authorization server 704 ID/information and if applicable, AIMLE client/VAL server ID/information. The ML repository may send an ML model information storage response to the authorization server 704 with an identifier of the created ML model profile.

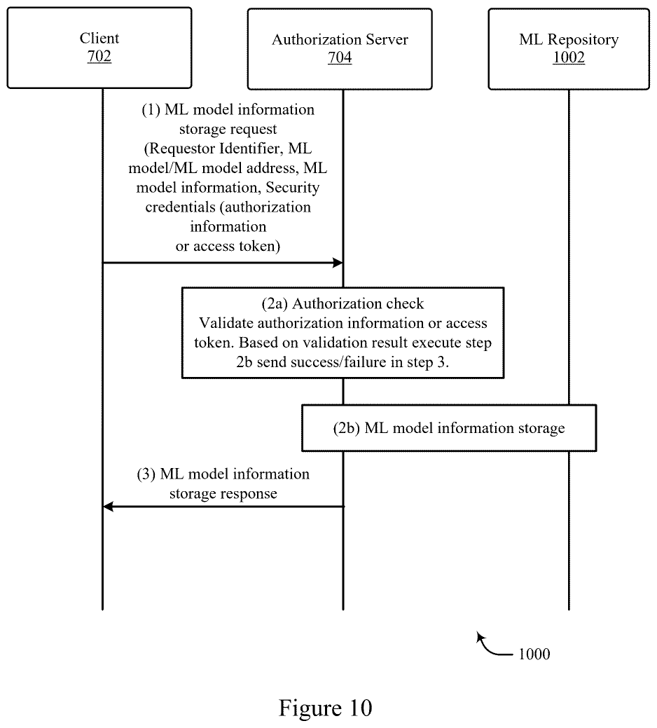

FIG. 10 illustrates a system 1000 in accordance with aspects of the present disclosure. The system 1000 illustrates an example implementation for AIMLE consumer-initiated ML model information storage. In the system 1000: At step (1), the client 702 sends an ML model information storage request to the authorization server 704 to store an ML model in an ML repository 1002. The request includes the security credentials, e.g., authentication information such as certificates, authorization token/information or an access token and information elements as described in Table 14. Alternatively, or in addition, the access token includes the claims such as requestor ID as subject, ML model storage service as scope, allowed ML information (model ID, model Type, or ML model identified by analytics ID or ML model address from where ML model can be downloaded), allowed AIMLE client ID (or) ML model source identifier (e.g., VAL server ID, VAL client ID, target ML repository information), related VAL service ID(s), ML model address, base Model ID, analytics ID, model size, domain information, related vendor ID(s), issuer claim as authorization server ID, and/or AIMLE server ID/SEAL server ID.

At steps (2a) and (2b), the authorization server 704 verifies the received security credentials, and if the verification is successful, the authorization server 704 sends an ML model information storage request to the ML repository 1002 to store the ML model in the ML repository 1002. Alternatively, or in addition, the client 702 forwards the received security to the ML repository 1002 in an ML model information storage request. In such scenarios, the ML repository 1002 may verify the received authorization information or access token, and if the verification is successful, the ML repository 1002 may store the received ML model information. At step (3), the authorization server 704 sends an ML model information storage response to the client 702 with the information elements as described in Table 14.

Implementations provide for ML model information discovery. In some implementations, an AIMLE consumer has requested to discover ML model or the authorization server 704 determines to discover an ML model for training. The authorization server 704 may send an ML model information discovery request to the ML repository 1002. The request includes the security credentials and information elements as described in Table 18, below. An access token in the security credentials includes the claims such as requestor ID as subject, ML model discovery service as scope, VAL service ID, ML model source identifier, allowed list of AIMLE member client IDs, allowed location information for member client selection, allowed ML model ID list/ML model information for discovery, ML model address, base model ID, analytics ID, allowed ML model training notification target address, ML model selection filtering criteria, domain information, required accuracy level, issuer claim as authorization Server ID, and/or AIMLE server ID/SEAL server ID.

The client 702 may obtain the authorization information or access token (which includes claims such as requestor ID as subject, ML model discovery service as scope, VAL service ID, ML model source identifier, allowed List of AIMLE member client IDs, allowed location information for member client selection, allowed ML model ID list/ML model Information for discovery, ML model address, base Model ID, analytics ID, allowed ML model training notification target address, ML Model selection filtering criteria, domain information, required accuracy level, issuer claim as authorization server ID, AIMLE server ID/SEAL server ID, etc.) from the authorization server 704 as described herein, when the access token request indicates ML Model discovery service in the access token request message.

Upon receiving the ML model information discovery request, the ML repository 1002 may verify if the requestor is authorized. The ML repository 1002, for example, verifies the received security credentials, and if the verification is successful, the ML repository 1002 considers the requestor as authorized to discover the ML model(s) identified by the ML model ID. Further, the ML repository 1002 verifies whether the requestor is present in the list of allowed vendors. If the ML repository consumer is authorized (e.g., security credentials verification is successful), the ML repository 1002 may process the request and discover the model based on ML model ID, analytics ID, base Model ID, and/or ML model interoperability information. If the discovery request is for transfer of learning, the ML repository 1002 may identify candidate models matching the domain and required accuracy level.

After the authorization server 704 receives the response from the ML repository 1002, the authorization server 704 may determine whether the received ML model satisfies the ML model parameter of the authorization server 704 and whether the authorization server 704 is to continuously train the model. The determination for continuous training may be based on the authorization server 704 capability for continuous training, parameters for the ML model, and ML model profile, e.g., indication of continuous model training, continuous training model parameter. The ML repository 1002 may send the response message to the ML repository consumer. The response may include information of the discovered ML model. When the ML model is within training or re-training phase, the ML model may not be available for discovery. Examples of such details are indicated within the Result IE in Table 19, below. The training and re-training phase can be used during federated learning to enable the AIMLE consumer to trust the ML repository 1002 to obtain the model details.

Table 14 describes example IEs for an information flow from the authorization server 704 to the ML repository 1002, or from the client 702 to the authorization server 704 as a request for the ML model information storage. In some implementations, authorization information or an access token can be part of security credentials. Alternatively, or in addition, if security credentials and authorization information/access token are in a separate IE, then security credentials can include client certificate and/or root certificate to validate the client certificate.

TABLE 14

| Information element | Description |
|---|---|
| Requestor Identity | The identity of the requestor performing |
| | the request. |
| Security credentials | The security credentials of the requestor |
| | e.g., client certificate and/or root |
| | certificate to validate the client certificate. |
| Authorization information | The access token includes the claims such |
| or access token | as Requestor ID as subject, ML model |
| | storage service as scope, Allowed ML |
| | information (Model ID, Model Type, or |
| | ML model identified by Analytics ID (or) |
| | ML model address from where ML model |
| | can be downloaded), Allowed AIMLE |
| | client ID (or) ML model source identifier |
| | (e.g., VAL server ID, VAL client ID, |
| | Target ML repository information), |
| | Related VAL service ID(s), ML model |
| | address, base Model ID, analytics ID, |
| | Model size, domain information, Related |
| | Vendor ID(s), Issuer claim as |
| | Authorization Server ID, AIMLE server |
| | ID/SEAL server ID etc. |
| ML model | The ML model to be stored in the ML |
| | repository. |
| ML model address | Represents the ML model address that can |
| | be used by Model repository to download |
| | the ML model. |
| ML model information | Provides information of the ML model. |

Table 15 describes example IEs for ML model information in accordance with aspects of the present disclosure.

TABLE 15

| Information element | Description |
|---|---|
| ML model identifier | An identifier for the ML model |
| Analytics ID | Represents analytics ID for which the |
| | model can be used. |
| ML model size | Indicates the size of the ML model. |
| ML model source identifier | The identifier of ML model source (e.g., |
| | VAL server ID, VAL client ID) that |
| | stored the model in the ML repository. |
| VAL service ID(s) | Identify the VAL service ID(s). |
| Domain | Specifies domain for which the model can |
| | be used (e.g., for speech recognition, |
| | image recognition, video processing, |
| | location prediction, etc.). |
| List of allowed vendors | Indicates which vendors that are allowed |
| | to use the ML model and thereby also are |
| | interoperable to the model. |
| ML model interoperability | Represents the vendor-specific |
| information | information that conveys, e.g., requested |
| | model file format, model execution |
| | environment, input/output parameters of |
| | the ML model, etc. The encoding, format, |
| | and value of ML Model Interoperable |
| | Information is not specified since it is |
| | vendor specific information, and is agreed |
| | between vendors, if necessary for sharing |
| | purposes. |
| ML Model phase | Represents the ML model phase, e.g., in |
| | training, trained, re-training, deployed. |
| > Observed performance | Provides information on the performance |
| | of the model e.g. accuracy, or application- |
| | specific performance metrics (if ML |
| | model is in trained or deployment phase). |
| > Training information | If the ML model is in trained or deployed |
| | phase: Information on the data that has |
| | been used to train the model (e.g. data |
| | sources, volume, freshness), and the base |
| | model ID in case of Transfer Learning. |
| > Indication of continuous | Indicates whether the model can be |
| model training | continuously trained or not. |
| > Continuous model | Parameters required for continuous model |
| training parameter | training. |
| ML model storage and | Represents the requirements for the ML |
| discovery requirements | repository for the ML model storage and |
| | discovery. |
| > Storage duration | Represents the ML model storage duration |
| | time. When the storage duration time is |
| | expired, the stored ML model and the |
| | related information shall be deleted. |
| > Security and access | Represents the information on security |
| requirements | requirements for storing the ML model |
| | information and the ML model access |
| | requirements (e.g., publicly available, |
| | private use only, or available for the list of |
| | VAL server IDs or VAL client IDs, time |
| | period and location access). If the access |
| | requirement is private use only, then the |
| | model is not discoverable by other |
| | consumers. |
| ML model usage | Represents the requirements for using the |
| requirements | ML model (e.g. for inference or for |
| | training). The requirements are used by |
| | the AIMLE server to determine whether |
| | an AIMLE client is capable of using the |
| | model based on comparing the |
| | requirements with information in the |
| | AIMLE client profile. |

Table 16 describes example IEs in an example information flow from the ML repository 1002 to the authorization server 704, or from the authorization server 704 to the client 702 as a response for the ML model information storage request.

TABLE 16

| Information element | Description |
|---|---|
| Result | Indicates success or failure of the request. |
| ML model profile identifier | The identifier of the ML model profile |
| | created as a result of a successful ML |
| | model storage request. |

Table 17 describes example IEs in an example ML model profile in accordance with aspects of the present disclosure.

TABLE 17

| Information element | Description |
|---|---|
| ML model profile identifier | The identifier of the ML model profile. |
| AIMLE server identifier | The identifier of the AIMLE server that |
| | stored the ML model. |
| ML repository identifier | The identifier of the ML repository where |
| | the ML model is stored. |
| ML model information | The information about the ML model. |
| ML model address | Represents the ML model address that can |
| | be used to download the ML model. |

Table 18 describes example IEs in an example information flow from the authorization server 704 to the ML repository 1002 as a request for the ML model information discovery. In some implementations, authorization information or an access token can be part of security credentials. Alternatively, or in addition, if security credentials and an authorization information/access token are in a separate IE, then security credentials can include client certificate and/or root certificate to validate the client certificate.

TABLE 18

| Information element | Description |
|---|---|
| Requester Identity | The identity of the ML repository |
| | consumer performing the request. |
| Security credentials | The security credentials of the requestor |
| | e.g., client certificate and/or root |
| | certificate to validate the client certificate. |
| Authorization information | The access token includes the claims such |
| or access token | as Requestor ID as subject, ML model |
| | discovery service as scope, VAL service |
| | ID, ML model source identifier, Allowed |
| | List of AIMLE member client IDs, |
| | Allowed location information for member |
| | client selection, Allowed ML Model ID |
| | list/ML Model Information for discovery, |
| | ML model address, base Model ID, |
| | analytics ID, allowed ML model training |
| | notification target address, ML Model |
| | selection filtering criteria, domain |
| | information, required accuracy level, |
| | Issuer claim as Authorization Server ID, |
| | AIMLE server ID/SEAL server ID etc., |
| Filtering criteria | Represents the filtering criteria, which can |
| | be ML model information. |

Table 19 describes example IEs in an example information flow from the ML repository 1002 to the authorization server 704 as a response for the ML model information discovery request.

TABLE 19

| Information element | Description |
|---|---|
| Successful response | Indicates that the request was successful. |
| >ML model profile list | Represents the ML model profile(s) of the |
| | discovered list of ML models. |
| > ML model ID | Represents the ML model ID. |
| > ML model list | Represents the ML model(s) of the |
| | discovered list of ML models. |
| > Indication of continuous | Indicate whether the model needs to be |
| model training | continuously trained or not. |
| Failure response | Indicates that the request failed. |
| > Cause | Indicates the failure cause. |

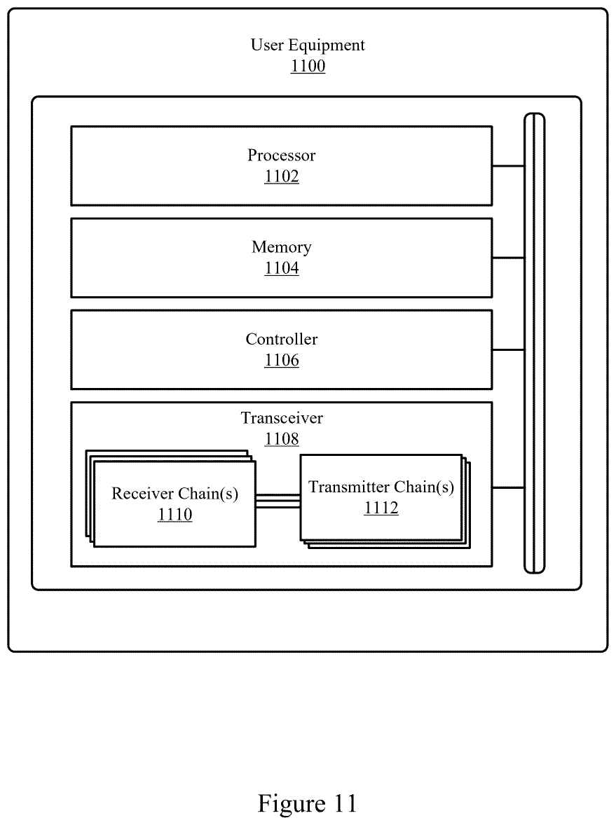

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the UE 1100 may support at least one memory (e.g., the memory 1104) and at least one processor (e.g., the processor 1102) coupled with the at least one memory and configured to cause the UE to transmit a first message including a request for an access token, wherein the first message includes first AI/ML model information; and receive a second message including the access token, wherein the access token includes second AI/ML model information.

Additionally, the UE 1100 may be configured to support any one or combination of where the first AI/ML model information includes an indication of one or more of an AI/ML model training service request, an AI/ML model storage service request, an AI/ML model retrieval service request, an AI/ML model management service request, or an AI/ML model discovery service request; the first AI/ML model information includes one or more of: an authorization scope parameter associated with the access token; an identifier for an artificial intelligence AI/ML server; or an identifier for an AI/ML model repository; the authorization scope parameter includes one or more of: AI/ML service information associated with AI/ML model management; one or more of VAL service information, a VAL server ID, a VAL UE ID, AIMLE client ID, or AI/ML client ID; or one or more of an AI/ML model ID, an AI/ML model address, or an analytics ID; the AI/ML service information associated with AI/ML model management includes information for one or more AI/ML model retrieval services; the apparatus includes an AI/ML client, an AIMLE client, a VAL server, or a VAL UE.

In some implementations, the UE 1100 may support at least one memory (e.g., the memory 1104) and at least one processor (e.g., the processor 1102) coupled with the at least one memory and configured to cause the UE to transmit a first message including an AI/ML model request, wherein the first message includes one or more of security credentials, authorization information, or an access token; and receive a second message including a response to the AI/ML model request.

Additionally, the UE 1100 may be configured to support any one or combination of where the AI/ML model request includes a request for AI/ML model retrieval, and wherein the one or more of the security information, the authorization information, or the access token includes AI/ML model retrieval information; the request for AI/ML model retrieval is associated with one or more of a request to subscribe to AI/ML model retrieval, a request to subscribe to AI/ML model retrieval notification, a request to subscribe to AI/ML model update, or a request to unsubscribe to AI/ML model retrieval; the AI/ML model request includes a request for AI/ML model training or AI/ML model training notification, and wherein the one or more of the authorization information or the access token includes AI/ML model training information; the AI/ML model request includes a request for AI/ML model storage management, and wherein the one or more of the authorization information or the access token includes AI/ML model storage management information; the apparatus includes an AI/ML client, an AIMLE client, or a VAL server; the security credentials include one or more of a client certificate or a root certificate configured to validate a client certificate.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

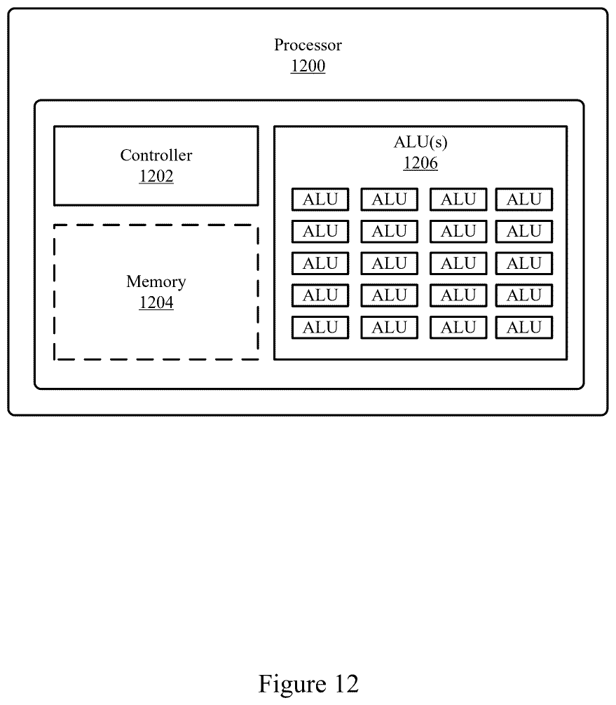

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory addresses of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, ALUs 1206, and other functional units of the processor 1200.

The memory 1204 may include one or more caches (e.g., memory local to or included in the processor 1200 or other memory, such as RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, and the controller 1202, and may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 may be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to transmit a first message including a request for an access token, wherein the first message includes first AI/ML model information; and receive a second message including the access token, wherein the access token includes second AI/ML model information.

Additionally, the processor 1200 may be configured to or operable to support any one or combination of where the first AI/ML model information includes an indication of one or more of an AI/ML model training service request, an AI/ML model storage service request, an AI/ML model retrieval service request, an AI/ML model management service request, or an AI/ML model discovery service request; the first AI/ML model information includes one or more of: an authorization scope parameter associated with the access token; an identifier for an artificial intelligence AI/ML server; or an identifier for an AI/ML model repository; the authorization scope parameter includes one or more of: AI/ML service information associated with AI/ML model management; one or more of VAL service information, a VAL server ID, a VAL UE ID, AIMLE client ID, or AI/ML client ID; or one or more of an AI/ML model ID, an AI/ML model address, or an analytics ID; the AI/ML service information associated with AI/ML model management includes information for one or more AI/ML model retrieval services; the apparatus includes an AI/ML client, an AIMLE client, a VAL server, or a VAL UE.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to receive a first message including a request for an access token, wherein the first message includes first AI/ML model information; and transmit a second message including the access token, wherein the access token includes second AI/ML model information.

Additionally, the processor 1200 may be configured to or operable to support any one or combination of where the first AI/ML model information includes an indication of one or more of an AI/ML model training service request, an AI/ML model storage service request, an AI/ML model retrieval service request, an AI/ML model management service request, or an AI/ML model discovery service request; and the second AI/ML model information includes one or more of AI/ML model training information, AI/ML model storage information, or AI/ML model discovery information; the second AI/ML model information includes one or more of: authorization scope information for AI/ML model management; one or more of an AI/ML server ID, AIMLE client ID, or an AI/ML model repository ID; one or more of VAL service information or VAL server information; one or more allowed AI/ML model retrieval filters; one or more of an AI/ML model ID, an AI/ML model address, or an analytics ID; or an authorization server ID.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to transmit a first message including an AI/ML model request, wherein the first message includes one or more of security credentials, authorization information, or an access token; and receive a second message including a response to the AI/ML model request.

Additionally, the processor 1200 may be configured to or operable to support any one or combination of where the AI/ML model request includes a request for AI/ML model retrieval, and wherein the one or more of the security information, the authorization information, or the access token includes AI/ML model retrieval information; the request for AI/ML model retrieval is associated with one or more of a request to subscribe to AI/ML model retrieval, a request to subscribe to AI/ML model retrieval notification, a request to subscribe to AI/ML model update, or a request to unsubscribe to AI/ML model retrieval; the AI/ML model request includes a request for AI/ML model training or AI/ML model training notification, and wherein the one or more of the authorization information or the access token includes AI/ML model training information; the AI/ML model request includes a request for AI/ML model storage management, and wherein the one or more of the authorization information or the access token includes AI/ML model storage management information; the apparatus includes an AI/ML client, an AIMLE client, or a VAL server; the security credentials include one or more of a client certificate or a root certificate configured to validate a client certificate.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to receive a first message including an AI/ML model request, wherein the first message includes one or more of security credentials, authorization information, or an access token; and transmit a second message including a response to the AI/ML model request, wherein the response is generated based on at least in part on one or more of the security credentials, authorization information or the access token.

Additionally, the processor 1200 may be configured to or operable to support any one or combination of where the AI/ML model request includes a request for AI/ML model retrieval, and wherein the at least one controller is configured to cause the processor to: perform an authorization procedure using at least a portion of the one or more of the security credentials, the authorization information, or the access token, wherein the response to the AI/ML model request includes a response to the request for AI/ML model retrieval that is generated based at least in part on a result of the authorization procedure; the request for AI/ML model retrieval is associated with one or more of a request to subscribe to AI/ML model retrieval, a request to subscribe to AI/ML model retrieval notification, a request to subscribe to AI/ML model update, or a request to unsubscribe to AI/ML model retrieval; the AI/ML model request includes a request for AI/ML model training, and wherein the at least one controller is configured to cause the processor to: perform an authorization procedure using at least a portion of the one or more of the security credentials, the authorization information, or the access token, wherein the response to the AI/ML model request includes a response to the request for AI/ML model training that is generated based at least in part on a result of the authorization procedure; the AI/ML model request includes a request for AI/ML model storage management, and wherein the at least one controller is configured to cause the processor to: perform an authorization procedure using at least a portion of the one or more of the security credentials, the authorization information, or the access token, wherein the response to the AI/ML model request includes a response to the request for AI/ML model storage management that is generated based at least in part on a result of the authorization procedure; the security credentials include one or more of a client certificate or a root certificate configured to validate a client certificate.

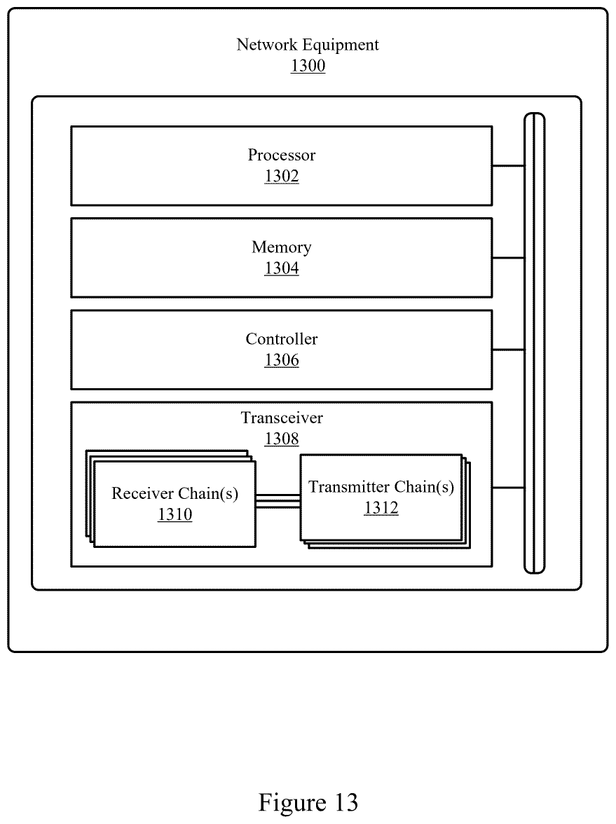

FIG. 13 illustrates an example of an NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein.

The NE 1300 may support at least one memory (e.g., the memory 1304) and at least one processor (e.g., the processor 1302) coupled with the at least one memory and configured to cause the NE to transmit a first message including a request for an access token, wherein the first message includes first AI/ML model information; and receive a second message including the access token, wherein the access token includes second AI/ML model information.

Additionally, the NE 1300 may be configured to support any one or combination of where the first AI/ML model information includes an indication of one or more of an AI/ML model training service request, an AI/ML model storage service request, an AI/ML model retrieval service request, an AI/ML model management service request, or an AI/ML model discovery service request; the first AI/ML model information includes one or more of: an authorization scope parameter associated with the access token; an identifier for an artificial intelligence AI/ML server; or an identifier for an AI/ML model repository; the authorization scope parameter includes one or more of: AI/ML service information associated with AI/ML model management; one or more of VAL service information, a VAL server ID, a VAL UE ID, AIMLE client ID, or AI/ML client ID; or one or more of an AI/ML model ID, an AI/ML model address, or an analytics ID; the AI/ML service information associated with AI/ML model management includes information for one or more AI/ML model retrieval services; the apparatus includes an AI/ML client, an AIMLE client, a VAL server, or a VAL UE.

The NE 1300 may support at least one memory (e.g., the memory 1304) and at least one processor (e.g., the processor 1302) coupled with the at least one memory and configured to cause the NE to receive a first message including a request for an access token, wherein the first message includes first AI/ML model information; and transmit a second message including the access token, wherein the access token includes second AI/ML model information.

Additionally, the NE 1300 may be configured to support any one or combination of where the first AI/ML model information includes an indication of one or more of an AI/ML model training service request, an AI/ML model storage service request, an AI/ML model retrieval service request, an AI/ML model management service request, or an AI/ML model discovery service request; and the second AI/ML model information includes one or more of AI/ML model training information, AI/ML model storage information, or AI/ML model discovery information; the second AI/ML model information includes one or more of: authorization scope information for AI/ML model management; one or more of an AI/ML server ID, AIMLE client ID, or an AI/ML model repository ID; one or more of VAL service information or VAL server information; one or more allowed AI/ML model retrieval filters; one or more of an AI/ML model ID, an AI/ML model address, or an analytics ID; or an authorization server ID.

The NE 1300 may support at least one memory (e.g., the memory 1304) and at least one processor (e.g., the processor 1302) coupled with the at least one memory and configured to cause the NE to transmit a first message including an AI/ML model request, wherein the first message includes one or more of security credentials, authorization information, or an access token; and receive a second message including a response to the AI/ML model request.

Additionally, the NE 1300 may be configured to support any one or combination of where the AI/ML model request includes a request for AI/ML model retrieval, and wherein the one or more of the security information, the authorization information, or the access token includes AI/ML model retrieval information; the request for AI/ML model retrieval is associated with one or more of a request to subscribe to AI/ML model retrieval, a request to subscribe to AI/ML model retrieval notification, a request to subscribe to AI/ML model update, or a request to unsubscribe to AI/ML model retrieval; the AI/ML model request includes a request for AI/ML model training or AI/ML model training notification, and wherein the one or more of the authorization information or the access token includes AI/ML model training information; the AI/ML model request includes a request for AI/ML model storage management, and wherein the one or more of the authorization information or the access token includes AI/ML model storage management information; the apparatus includes an AI/ML client, an AIMLE client, or a VAL server; the security credentials include one or more of a client certificate or a root certificate configured to validate a client certificate.

The NE 1300 may support at least one memory (e.g., the memory 1304) and at least one processor (e.g., the processor 1302) coupled with the at least one memory and configured to cause the NE to receive a first message including an AI/ML model request, wherein the first message includes one or more of security credentials, authorization information, or an access token; and transmit a second message including a response to the AI/ML model request, wherein the response is generated based on at least in part on one or more of the security credentials, authorization information or the access token.

Additionally, the NE 1300 may be configured to support any one or combination of where the AI/ML model request includes a request for AI/ML model retrieval, and wherein the at least one processor is configured to cause the NE to: perform an authorization procedure using at least a portion of the one or more of the security credentials, the authorization information, or the access token, wherein the response to the AI/ML model request includes a response to the request for AI/ML model retrieval that is generated based at least in part on a result of the authorization procedure; the request for AI/ML model retrieval is associated with one or more of a request to subscribe to AI/ML model retrieval, a request to subscribe to AI/ML model retrieval notification, a request to subscribe to AI/ML model update, or a request to unsubscribe to AI/ML model retrieval; the AI/ML model request includes a request for AI/ML model training, and wherein the at least one processor is configured to cause the NE to: perform an authorization procedure using at least a portion of the one or more of the security credentials, the authorization information, or the access token, wherein the response to the AI/ML model request includes a response to the request for AI/ML model training that is generated based at least in part on a result of the authorization procedure; the AI/ML model request includes a request for AI/ML model storage management, and wherein the at least one processor is configured to cause the NE to: perform an authorization procedure using at least a portion of the one or more of the security credentials, the authorization information, or the access token, wherein the response to the AI/ML model request includes a response to the request for AI/ML model storage management that is generated based at least in part on a result of the authorization procedure; the security credentials include one or more of a client certificate or a root certificate configured to validate a client certificate.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

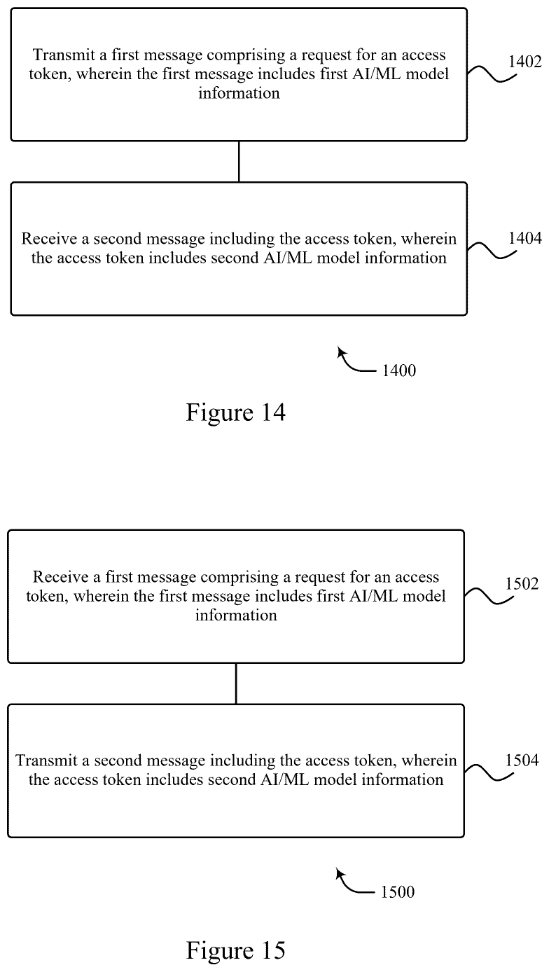

FIG. 14 illustrates a flowchart of a method 1400 in accordance with aspects of the present disclosure. The operations of the method may be implemented by a UE or an NE as described herein. In some implementations, the UE or the NE may execute a set of instructions to control the function elements of the UE or the NE to perform the described functions. It should be noted that the method described herein describes a possible implementation, and that the operations and the steps may be rearranged or otherwise modified and that other implementations are possible.

At 1402, the method may include transmitting a first message comprising a request for an access token, wherein the first message includes first AI/ML model information. The operations of 1402 may be performed in accordance with examples as described herein. In some implementations, aspects of the operations of 1402 may be performed by a UE as described with reference to FIG. 11 or an NE as described with reference to FIG. 13.

At 1404, the method may include receiving a second message including the access token, wherein the access token includes second AI/ML model information. The operations of 1404 may be performed in accordance with examples as described herein. In some implementations, aspects of the operations of 1404 may be performed by a UE as described with reference to FIG. 11 or an NE as described with reference to FIG. 13.

FIG. 15 illustrates a flowchart of a method 1500 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1502, the method may include receiving a first message comprising a request for an access token, wherein the first message includes first AI/ML model information. The operations of 1502 may be performed in accordance with examples as described herein. In some implementations, aspects of the operations of 1502 may be performed by an NE as described with reference to FIG. 13.

At 1504, the method may include transmitting a second message including the access token, wherein the access token includes second AI/ML model information. The operations of 1504 may be performed in accordance with examples as described herein. In some implementations, aspects of the operations of 1504 may be performed by an NE as described with reference to FIG. 13.

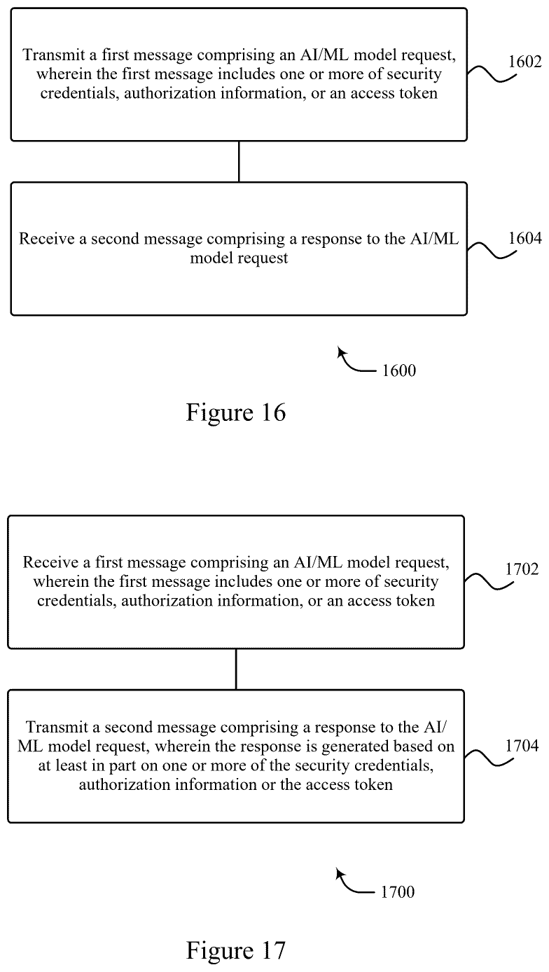

FIG. 16 illustrates a flowchart of a method 1600 in accordance with aspects of the present disclosure. The operations of the method may be implemented by a UE or an NE as described herein. In some implementations, the UE or the NE may execute a set of instructions to control the function elements of the UE or the NE to perform the described functions. It should be noted that the method described herein describes a possible implementation, and that the operations and the steps may be rearranged or otherwise modified and that other implementations are possible.

At 1602, the method may include transmitting a first message comprising an AI/ML model request, wherein the first message includes one or more of security credentials, authorization information, or an access token. The operations of 1602 may be performed in accordance with examples as described herein. In some implementations, aspects of the operations of 1602 may be performed by a UE as described with reference to FIG. 11 or an NE as described with reference to FIG. 13.

At 1604, the method may include receiving a second message comprising a response to the AI/ML model request. The operations of 1604 may be performed in accordance with examples as described herein. In some implementations, aspects of the operations of 1604 may be performed by a UE as described with reference to FIG. 11 or an NE as described with reference to FIG. 13.

FIG. 17 illustrates a flowchart of a method 1700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1702, the method may include receiving a first message comprising an AI/ML model request, wherein the first message includes one or more of security credentials, authorization information, or an access token. The operations of 1702 may be performed in accordance with examples as described herein. In some implementations, aspects of the operations of 1702 may be performed by an NE as described with reference to FIG. 13.

At 1704, the method may include transmitting a second message comprising a response to the AI/ML model request, wherein the response is generated based on at least in part on one or more of the security credentials, authorization information or the access token. The operations of 1704 may be performed in accordance with examples as described herein. In some implementations, aspects of the operations of 1704 may be performed by an NE as described with reference to FIG. 13.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and operable to cause the apparatus to:
transmit a first message comprising a request for an access token, wherein the first message includes first artificial intelligence (AI) machine learning (ML) model information; and
receive a second message including the access token, wherein the access token includes second AI/ML model information.

2. The apparatus of claim 1, wherein the first AI/ML model information comprises an indication of one or more of an AI/ML model training service request, an AI/ML model storage service request, an AI/ML model retrieval service request, an AI/ML model management service request, or an AI/ML model discovery service request.

3. The apparatus of claim 1, wherein the first AI/ML model information comprises one or more of:
an authorization scope parameter associated with the access token;
an identifier for an artificial intelligence AI/ML server; or
an identifier for an AI/ML model repository.

4. The apparatus of claim 3, wherein the authorization scope parameter comprises one or more of:
AI/ML service information associated with AI/ML model management;
one or more of vertical application layer (VAL) service information, a VAL server identifier (ID), a VAL user equipment (UE) ID, AI/ML enabler (AIMLE) client ID, or AI/ML client ID; or
one or more of an AI/ML model ID, an AI/ML model address, or an analytics ID.

5. The apparatus of claim 4, wherein the AI/ML service information associated with AI/ML model management comprises information for one or more AI/ML model retrieval services.

6. An apparatus for wireless communication, comprising:
at least one memory; and
at least one processor coupled with the at least one memory and operable to cause the apparatus to:
receive a first message comprising a request for an access token, wherein the first message includes first artificial intelligence (AI) machine learning (ML) model information; and
transmit a second message including the access token, wherein the access token includes second AI/ML model information.

7. The apparatus of claim 6, wherein:
the first AI/ML model information comprises an indication of one or more of an AI/ML model training service request, an AI/ML model storage service request, an AI/ML model retrieval service request, an AI/ML model management service request, or an AI/ML model discovery service request; and
the second AI/ML model information comprises one or more of AI/ML model training information, AI/ML model storage information, or AI/ML model discovery information.

8. The apparatus of claim 6, wherein the second AI/ML model information comprises one or more of:
authorization scope information for AI/ML model management;
one or more of an AI/ML server identifier (ID), AI/ML enabler (AIMLE) client ID, or an AI/ML model repository ID;
one or more of vertical application layer (VAL) service information or VAL server information;
one or more allowed AI/ML model retrieval filters;
one or more of an AI/ML model ID, an AI/ML model address, or an analytics ID; or
an authorization server ID.

9. An apparatus for wireless communication, comprising:
at least one memory; and
at least one processor coupled with the at least one memory and operable to cause the apparatus to:
transmit a first message comprising an artificial intelligence (AI) machine learning (ML) model request, wherein the first message includes one or more of security credentials, authorization information, or an access token; and
receive a second message comprising a response to the AI/ML model request.

10. The apparatus of claim 9, wherein the AI/ML model request comprises a request for AI/ML model retrieval, and wherein the one or more of the security information, the authorization information, or the access token comprises AI/ML model retrieval information.

11. The apparatus of claim 10, wherein the request for AI/ML model retrieval is associated with one or more of a request to subscribe to AI/ML model retrieval, a request to subscribe to AI/ML model retrieval notification, a request to subscribe to AI/ML model update, or a request to unsubscribe to AI/ML model retrieval.

12. The apparatus of claim 9, wherein the AI/ML model request comprises a request for AI/ML model training or AI/ML model training notification, and wherein the one or more of the authorization information or the access token comprises AI/ML model training information.

13. The apparatus of claim 9, wherein the AI/ML model request comprises a request for AI/ML model storage management, and wherein the one or more of the authorization information or the access token comprises AI/ML model storage management information.

14. The apparatus of claim 9, wherein the apparatus comprises an AI/ML client, an AI/ML enabler (AIMLE) client, or a vertical application layer (VAL) server.

15. The apparatus of claim 9, wherein the security credentials comprise one or more of a client certificate or a root certificate configured to validate a client certificate.

16. An apparatus for wireless communication, comprising:
at least one memory; and
at least one processor coupled with the at least one memory and operable to cause the apparatus to:
receive a first message comprising an artificial intelligence (AI) machine learning (ML) model request, wherein the first message includes one or more of security credentials, authorization information, or an access token; and
transmit a second message comprising a response to the AI/ML model request, wherein the response is generated based on at least in part on one or more of the security credentials, authorization information or the access token.

17. The apparatus of claim 16, wherein the AI/ML model request comprises a request for AI/ML model retrieval, and wherein the at least one processor is configured to cause the apparatus to:
perform an authorization procedure using at least a portion of the one or more of the security credentials, the authorization information, or the access token, wherein the response to the AI/ML model request comprises a response to the request for AI/ML model retrieval that is generated based at least in part on a result of the authorization procedure.

18. The apparatus of claim 17, wherein the request for AI/ML model retrieval is associated with one or more of a request to subscribe to AI/ML model retrieval, a request to subscribe to AI/ML model retrieval notification, a request to subscribe to AI/ML model update, or a request to unsubscribe to AI/ML model retrieval.

19. The apparatus of claim 16, wherein the AI/ML model request comprises a request for AI/ML model training, and wherein the at least one processor is configured to cause the apparatus to:
perform an authorization procedure using at least a portion of the one or more of the security credentials, the authorization information, or the access token, wherein the response to the AI/ML model request comprises a response to the request for AI/ML model training that is generated based at least in part on a result of the authorization procedure.

20. The apparatus of claim 16, wherein the AI/ML model request comprises a request for AI/ML model storage management, and wherein the at least one processor is configured to cause the apparatus to:
perform an authorization procedure using at least a portion of the one or more of the security credentials, the authorization information, or the access token, wherein the response to the AI/ML model request comprises a response to the request for AI/ML model storage management that is generated based at least in part on a result of the authorization procedure.
